(19) United States
(12) Patent Application Publication
(10) Pub. No.: US 2025/0168682 A1
(43) Pub. Date: May 22, 2025

(54) METHODS, DEVICES, AND COMPUTER READABLE MEDIUM FOR COMMUNICATION

(71) Applicant: NEC CORPORATION, Tokyo (JP)

(72) Inventors: Peng GUAN, Beijing (CN); Yukai GAO, Beijing (CN); Gang WANG, Beijing (JP)

(73) Assignee: NEC CORPORATION, Tokyo (JP)

(21) Appl. No.: 18/839,325

(22) PCT Filed: Feb. 18, 2022
(86) PCT No.: PCT/CN2022/076949

§ 371 Date: Aug. 16, 2024

(51) Int. Cl. H04W 24/10; H04B 17/382; H04L 5/00; H04L 41/16

(52) U.S. Cl. CPC H04W 24/10; H04B 17/382; H04L 5/0051; H04L 41/16

(57) ABSTRACT

Embodiments of the present disclosure relate to methods, devices, and computer readable medium for communication. According to embodiments of the present disclosure, a terminal device receives a measurement configuration or transmission configuration from a network device. The terminal device performs a measurement based on the measurement configuration and report results of the measurement to the network device. Alternatively, if the terminal device performs transmissions based on the transmission configuration, the network device performs a measurement based on the transmissions. The network device trains an intelligent (AI) or machine learning (ML) based on the results of the measurement. In this way, the real measurement results are used for constructing a suitable dataset for the AI or ML model at the network device.

### TECHNICAL FIELD

Embodiments of the present disclosure generally relate to the field of telecommunication, and in particular, to methods, devices, and computer readable medium for communication.

### BACKGROUND

Several technologies have been proposed to improve communication performances. For example, communication devices may employ an artificial intelligent/machine learning (AI/ML) model to improve communication qualities. The AI/ML model can be applied to different scenarios to achieve better performances. Thus, how to properly train the AI/ML model is worth studying, in order to ensure satisfying communication performances.

### SUMMARY

In general, example embodiments of the present disclosure provide a solution for communication.

In a first aspect, there is provided a method for communication. The communication method comprises: receiving, at a terminal device and from a network device, a first configuration indicating at least one subset of resources from a first set of resources, wherein the at least one subset of resources is for constructing a first dataset for training a first artificial intelligent (AI)/machine learning (ML) model at the network device, and the first dataset comprises at least one of: a training dataset for model training, a validation dataset for model training, a test dataset for model training, or a dataset for model inference; and transmitting, to the network device, information on quality determination based on the at least one subset of resources, wherein the information is for constructing the first dataset.

In a second aspect, there is provided a method for communication. The communication method comprises: transmitting, at a network device and to a terminal device, a first configuration indicating at least one subset of resources from a first set of resources, wherein the at least one subset of resources is for constructing a first dataset for training a first artificial intelligent (AI)/machine learning (ML) model at the network device, and the first dataset comprises at least one of: a training dataset for model training, a validation dataset for model training, a test dataset for model training, or a dataset for model inference; and receiving, from the terminal device, information on quality determination based on the at least one subset of resources, wherein the information is for constructing the first dataset.

In a third aspect, there is provided a terminal device. The terminal device comprises a processing unit; and a memory coupled to the processing unit and storing instructions thereon, the instructions, when executed by the processing unit, causing the terminal device to perform acts comprising: receiving, from a network device, a first configuration indicating at least one subset of resources from a first set of resources, wherein the at least one subset of resources is for constructing a first dataset for training a first artificial intelligent (AI)/machine learning (ML) model at the network device, and the first dataset comprises at least one of: a training dataset for model training, a validation dataset for model training, a test dataset for model training, or a dataset for model inference; and transmitting, to the network device, information on quality determination based on the at least one subset of resources, wherein the information is for constructing the first dataset.

In a fourth aspect, there is provided a network device. The network device comprises a processing unit; and a memory coupled to the processing unit and storing instructions thereon, the instructions, when executed by the processing unit, causing the network device to perform acts comprising: transmitting, to a terminal device, a first configuration indicating at least one subset of resources from a first set of resources, wherein the at least one subset of resources is for constructing a first dataset for training a first artificial intelligent (AI)/machine learning (ML) model at the network device, and the first dataset comprises at least one of: a training dataset for model training, a validation dataset for model training, a test dataset for model training, or a dataset for model inference; and receiving, from the terminal device, information on quality determination based on the at least one subset of resources, wherein the information is for constructing the first dataset.

In a fifth aspect, there is provided a computer readable medium having instructions stored thereon, the instructions, when executed on at least one processor, causing the at least one processor to carry out the method according to the first or second aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 is a schematic diagram of a communication environment in which embodiments of the present disclosure can be implemented;

FIG. 2A illustrates a schematic diagram of an AI/ML model which can be implemented at the network device;

FIG. 2B illustrates a schematic diagram of datasets constructed for the AI/ML model;

FIG. 3 illustrates a signaling flow for communications according to some embodiments of the present disclosure;

FIGS. 4A-4C illustrate signaling flows for communications according to some embodiments of the present disclosure, respectively;

FIGS. 5A-5C illustrate signaling flows for communications according to some according to some embodiments of the present disclosure, respectively;

FIG. 6A-6D illustrate schematic diagrams of inputs and outputs of the AI/ML model according to some embodiments of the present disclosure, respectively;

FIGS. 7A and 7B show schematic diagrams of datasets according to some embodiments of the present disclosure, respectively;

FIG. 8 is a flowchart of an example method in accordance with an embodiment of the present disclosure;

FIG. 9 is a flowchart of an example method in accordance with an embodiment of the present disclosure; and

FIG. 10 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device. In the following description, the terms “terminal device”, “communication device”, “terminal”, “user equipment” and “UE” may be used interchangeably.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz-7125 MHz), FR2 (24.25 GHz to 71 GHz), frequency band larger than 100 GHz as well as Terahertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), a network management entity, for example, an Operations, Administration and Maintenance (OAM) entity and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

Communications discussed herein may use conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.85G, the third generation (3G), the fourth generation (4G), 4.5G, the fifth generation (5G), and the sixth (6G) communication protocols. The techniques described herein may be used for the wireless networks and radio technologies mentioned above as well as other wireless networks and radio technologies. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As mentioned above, the AI/ML model can be applied to different scenarios to achieve better performances. In some embodiments, the AI/ML model can be implemented at the network device side. Alternatively, the AI/ML model can be implemented at the terminal device side. In other embodiments, the AI/ML model can be implemented at both the network device and the terminal device.

For example, the terminal devices can perform the beam management on the AI/ML model. In this case, the terminal device can measure a part of candidate beam pairs and use AI or ML to estimate qualities for all candidate beam pairs. Massive MIMO (mMIMO) and beamforming are widely used in the telecom industry. Terms “beamforming” and “mMIMO” are sometimes used interchangeably. In general, beamforming uses multiple antennas to control the direction of a wave-front by appropriately weighting the magnitude and phase of individual antenna signals in an array of multiple antennas. The most commonly seen definition is that mMIMO is a system where the number of antennas exceeds the number of users. The coverage is beam-based in 5G, not cell based. There is no cell-level reference channel from where the coverage of the cell could be measured. Instead, each cell has one or multiple Synchronization Signal Block Beam (SSB) beams. SSB beams are static, or semi-static, always pointing to the same direction. They form a grid of beams covering the whole cell area. The user equipment (UE) searches for and measure the beams, maintaining a set of candidate beams. The candidate set of beams may contain beams from multiple cells. With 5G millimeter wave (mmWave) enabling directional communication with a larger number of antenna elements and providing an additional beamforming gain, efficient management of beams—where UE and gNB regularly identify the optimal beams to work on at any given point of time—has become crucial.

Additionally, the terminal device can perform CSI feedback based on the AI/ML model. In this situation, the original CSI information can be compressed by an AI encoder located in the terminal device, and recovered by an AI decoder located in the network device. The AI/ML model can also be sued for reference signal (RS) overhead reduction. For example, the terminal device can use a new RS pattern, such as, lower density DMRS, less CSI-RS port.

In many studies, 3GPP channel model (statistical model) is used to generate all samples. Samples in training/validation/testing dataset are naturally independent and identically distributed. The AI/ML model can be trained and deployed solely by network, with no real measurement. However, in the field, real channel characteristic and real implementation are different from a statistical model. The statistical model may not be suitable for the real environment. Thus, it is worthy proposing new solutions on constructing a suitable dataset for the AI/ML model.

In order to solve at least part of the above issues and other potential issues, solutions on improving the AI/ML model are proposed. According to embodiments of the present disclosure, a terminal device receives a measurement configuration or transmission configuration from a network device. The terminal device performs a measurement based on the measurement configuration and report results of the measurement to the network device. Alternatively, if the terminal device performs transmissions based on the transmission configuration, the network device performs a measurement based on the transmissions. The network device trains an AI/ML model based on the results of the measurement. In this way, the real measurement results are used for constructing a suitable dataset for the AI/ML model at the network device.

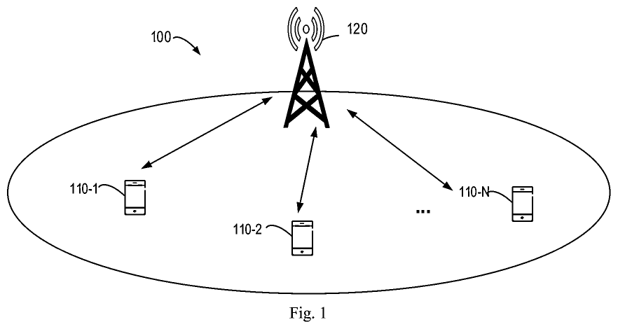

FIG. 1 illustrates a schematic diagram of a communication system in which embodiments of the present disclosure can be implemented. The communication system 100, which is a part of a communication network, comprises a terminal device 110-1, a terminal device 110-2, . . . , a terminal device 110-N, which can be collectively referred to as “terminal device(s) 110.” The number N can be any suitable integer number. The terminal devices 110 can communicate with each other.

The communication system 100 further comprises a network device. In the communication system 100, the network device 120 and the terminal devices 110 can communicate data and control information to each other. The numbers of terminal devices shown in FIG. 1 are given for the purpose of illustration without suggesting any limitations.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

Embodiments of the present disclosure can be applied to any suitable scenarios. For example, embodiments of the present disclosure can be implemented at reduced capability NR devices. Alternatively, embodiments of the present disclosure can be implemented in one of the followings: NR multiple-input and multiple-output (MIMO), NR sidelink enhancements, NR systems with frequency above 52.6 GHz, an extending NR operation up to 71 GHz, narrow band-Internet of Thing (NB-IoT)/enhanced Machine Type Communication (eMTC) over non-terrestrial networks (NTN), NTN, UE power saving enhancements, NR coverage enhancement, NB-IoT and LTE-MTC, Integrated Access and Backhaul (IAB), NR Multicast and Broadcast Services, or enhancements on Multi-Radio Dual-Connectivity.

The term “slot” used herein refers to a dynamic scheduling unit. One slot comprises a predetermined number of symbols. The term “downlink (DL) sub-slot” may refer to a virtual sub-slot constructed based on uplink (UL) sub-slot. The DL sub-slot may comprise fewer symbols than one DL slot. The slot used herein may refer to a normal slot which comprises a predetermined number of symbols and also refer to a sub-slot which comprises fewer symbols than the predetermined number of symbols. The terms “beam”, “beam pair”, “beam pair link” used herein refers to communication links and can be represented by “resource”, “resource set” or “resource setting”, “resource configuration”. The terms “beam quality” used herein refers to “RSRP”, “SINR”, “RSSI” or “RSRQ” measured or on the corresponding resource or measured via the corresponding beam. The terms “precoder”, “precoding”, “precoding matrix”, “beam”, “spatial relation information”, “spatial domain transmission filter”, “spatial domain filter”, “spatial parameter”, “spatial relation information”, “spatial relation info”, “TPMI”, “precoding information”, “precoding information and number of layers”, “precoding matrix indicator (PMI)”, “precoding matrix indicator”, “transmission precoding matrix indication”, “precoding matrix indication”, “TCI state”, “transmission configuration indicator”, “quasi co-location (QCL)”, “quasi-co-location”, “QCL parameter” and “spatial relation” can be used interchangeably. The terms “SRI”, “SRS resource set index”, “UL TCI”, “UL spatial domain filter”, “UL beam”, “joint TCI” can be used interchangeably. The terms “candidate”, “predicted”, “target” and “potential” can be used interchangeably.

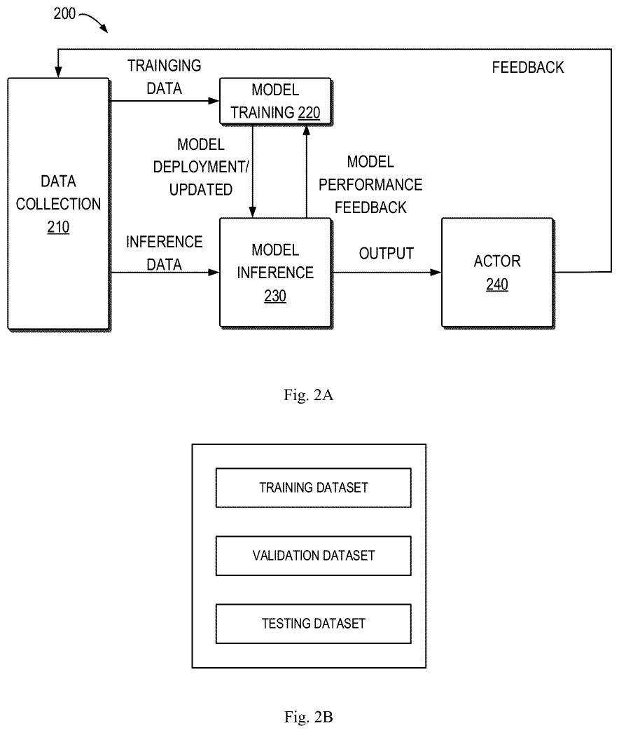

FIG. 2A shows a schematic diagram of the AI/ML model. The AI/ML model 200 can be implemented at the network device 120. The term “AI/ML model” used herein can refer to a program or algorithm that utilizes a set of data that enables it to recognize certain patterns. This allows it to reach a conclusion or make a prediction when provided with sufficient information. Generally, the AI/ML model can be a mathematical algorithm that is “trained” using data and human expert input to replicate a decision an expert would make when provided that same information.

According to embodiments of the present disclosure, the AI/ML model 200 can be used for learning how to generate output based on input for beam management. For example, in this case, the input of the AI/ML model can at least comprise a subset K1 of beams and optionally their RSRPs, and the output can at least comprise recovered set K (K>K1) of beams with their RSRPs or the beast beam with its RSRP. In some embodiments, the time domain prediction may be considered. In this case, the input of the AI/ML model can be at time n−T and the output of the AI/ML model can be at time n. Alternatively, according to some embodiments of the present disclosure, the AI/ML model 200 can be used to learn how to find narrow beam based on wide beam information. In this case, the input of the AI/ML model can at least comprise a set K′ of wide beams, and optionally their RSRPs and the output of the AI/ML model can at least comprise recovered set K of narrow beams and their RSRPs or the Alt2 best beam in K, and optionally its RSRP. The wide beam can be beams used in initial access, the narrow beam can be beams used for UE specific data transmission. In some embodiments, different AI/ML models can be used for different subset K1 selection.

As shown in FIG. 2A, the AI/ML model 200 may comprise a data collection 210, a model training 220, a model inference 230 and an actor 240. The data collection 210 is a function that provides input data to model training 220 and model inference 230. AI/ML algorithm specific data preparation (e.g., data pre-processing and cleaning, formatting, and transformation) is not carried out in the data collection 210. Examples of input data may include measurements from UEs or different network entities, feedback from actor the 240, output from an AI/ML model. The term “training data” used herein can refer to data needed as input for the model training 220. The term “inference data” used herein can refer to data needed as input for the model inference 230.

The model training 220 is a function that performs the ML model training, validation, and testing which may generate model performance metrics as part of the model testing procedure. The model training 220 is also responsible for data preparation (e.g., data pre-processing and cleaning, formatting, and transformation) based on training Data delivered by the data collection 210, if required. As shown in FIG. 2B, there may be three datasets for the model training 220, the training dataset, the validation dataset, and the testing dataset. The model training 220 may use model deployment/updated to initially deploy a trained, validated, and tested AI/ML model to the model inference 230 or to deliver an updated model to the model inference 230. The classification of different datasets is according to the common practice in machine learning. The training dataset can be used to directly improve a model's parameters. The validation dataset can be used to evaluate a model's performance while optimizing the model's hyperparameters. The testing dataset can be used to evaluate a model after hyperparameter optimization is completed.

The model inference 230 is a function that provides AI/ML model inference output (e.g., predictions or decisions). It may provide model performance feedback to the model training 220. The model inference 230 is also responsible for data preparation (e.g., data pre-processing and cleaning, formatting, and transformation) based on the inference data delivered by the data collection 210, if required.

Actor 210 is a function that receives the output from the model inference 230 and triggers or performs corresponding actions. The Actor 210 may trigger actions directed to other entities or to itself.

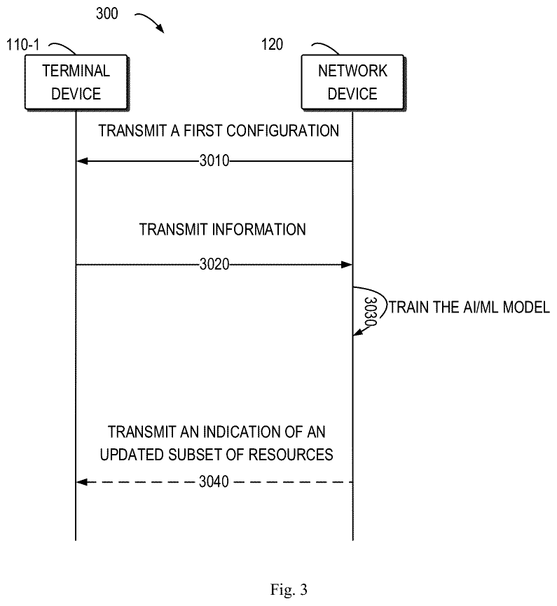

Reference is first made to FIG. 3, which shows a signaling chart illustrating process 300 between the terminal device and the network device according to some example embodiments of the present disclosure. Only for the purpose of discussion, the process 300 will be described with reference to FIG. 1. The process 300 may involve the terminal device 110-1 and the network device 120 in FIG. 1. The process 300 can be used for collecting field data for AI/ML model training. The collecting field data for AI/ML model training can be with aperiodic or semi-persistent configuration/measurement/report and has a lower priority than data traffic transmission and other normal configuration/measurement/report. The collecting field data for Model training can done within the time window/duration or the duty cycle the terminal device suggests or requests based on its own capability.

The network device 120 transmits 3010 a first configuration to the terminal device 110-1. The first configuration indicates at least one subset of resources from a first set of resources. In some embodiments, the first set of resources may comprise resources for beam measurement and report. The at least one subset of resource is for constructing a first dataset for training the AI/ML model 200 at the network device 120. The first dataset comprises one or more of: a training dataset for model training, a validation dataset for model training, a test dataset for model training, or a dataset for model inference.

In some embodiments, the first configuration may be the first measurement configuration. In this case, the terminal device 110-1 may perform the measurement on the at least one subset of resources based on the first measurement configuration. For example, the first configuration may indicate a first candidate data sample for constructing the first dataset. The first candidate data sample may comprise a subset of resources as input of the AI/ML model and a target resource as output of the AI/ML model. It should be noted that the input and/or output of the AI/ML model can also comprise other parameters not limited to the subset of resources and the target resource. Alternatively, the first configuration may indicate the terminal device 110-1 to perform measurements on the first set of resources. In some embodiments, the terminal device 110-1 may determine qualities based on results of the measurement. For example, the terminal device 110-1 may determine reference signal received power (RSRP) based on the measurement. Alternatively, the terminal device 110-1 may determine signal plus interference to noise ratio (SINR) based on the measurement.

In other embodiments, the first configuration may be the first transmission configuration. In this case, the terminal device may perform transmissions based on the first transmission configuration. For example, the first configuration may indicate a set of reference signal resources for sounding reference signal (SRS). Alternatively or in addition, the first configuration may indicate a subset of reference signal resources from the set of reference signal resources. In other embodiments, the first configuration may indicate a target reference signal resource.

The terminal device 110-1 transmits 3020 information to the network device 120. In some embodiments, if the first configuration is the first measurement configuration, the terminal device 110-1 may transmit results of the measurement to the network device 120. Alternatively, if the first configuration is the first transmission configuration, the terminal device 110-1 may transmit sounding reference signals to the network device 120. In this case, the network device 120 can measure the sounding reference signals.

The network device 120 trains 3030 the AI/ML model. The network device 120 may construct the first dataset based on the result of the measurements. The AI/ML model can be trained based on the first dataset. In this way, the AI/ML model can be optimized based on real measurement results.

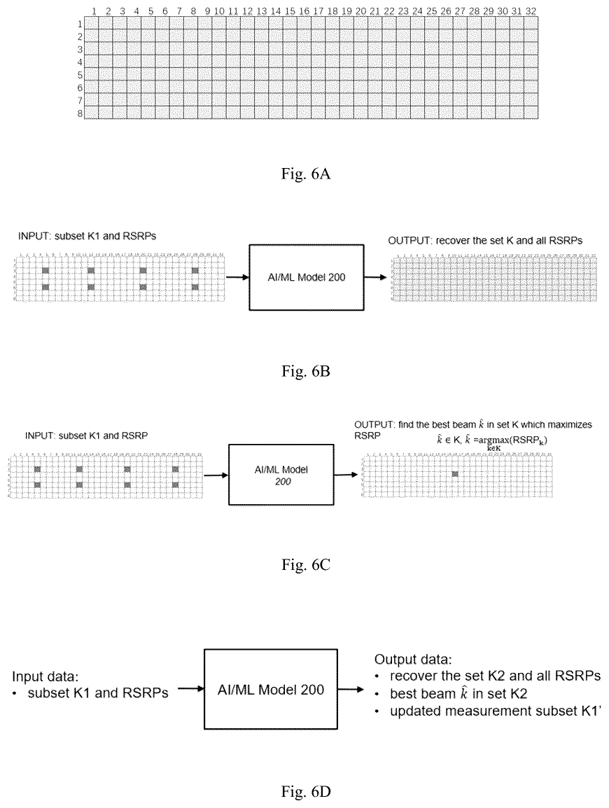

The network device 120 may transmit 3040 an indication of an updated subset of resources to the terminal device 110-1. As shown in FIG. 6D, the updated subset of resources can be output from the AI/ML model. In some embodiments, the updated subset of resources can be the input of AI/ML model training. Alternatively or in addition, the updated subset of resources can be used for collecting data for AI/ML model training. In other embodiments, the updated subset of resources can be used for collecting data for AI/ML model inference. In some other embodiments, the updated subset of resources can be used for normal beam measurement and report. In this way, it can avoid randomly selected measurement subset and can provide better prediction performance.

In some embodiments, explicit signaling may be needed to inform the terminal device 110-1 about the updated measurement subset K1′. For example, the input of the AI/ML model training can be updated based on the updated subset of resources. In other embodiments, the updated subset of resources can be transmitted in the first measurement configuration, which means that the configuration for collecting data for AI/ML model training can be updated. In this case, the RRC IE ‘RS-subset-to-measure-for-training’ and ‘RS-to-compare-for-training’ can be used for informing the updated subset of resources. Alternatively, the updated subset of resources can be transmitted in the second measurement configuration, which means that the configuration for collecting data for AI/ML model inference can be updated. In this case, a new signaling ‘RS-subset-measure-for-inference’ can be used for informing the updated subset of resources. As mentioned above, different AI/ML models can be used for different subset K1 selection. In other words, multiple AI/ML models (model i) can be learning how to generate K from different version of K1_i. In this case, instead of using K1′ as the output, the AI/ML model ID i can be used as output if one version of K1 selection corresponds one AI/ML model.

In some embodiments, the input from the terminal device 110-1 for the first AI/ML mode can comprise one or more of: number of Tx/Rx beam/panel, beamforming gain, beam width, location information, trajectory, velocity, orientation, moving direction, transmit power, measurement subset of Tx/Rx beams, transmission scheme, wide beam used in initial access. The input from the network device 120 for the AI/ML model can comprise one or more of: number of Tx/Rx beam/panel, beamforming gain, beam width, location information, transmit power, handover, measurement subset of Tx/Rx beams, scheduling information, beam switch decision, multi-user scheduling decision, traffic status, transmission scheme, wide beam used in initial access. The input from other terminal devices for the AI/ML model can comprise one or more of: number of Tx/Rx beam/panel, beamforming gain, beam width, location information, trajectory, velocity, orientation, moving direction, transmit power, measurement subset of Tx/Rx beams, transmission scheme, wide beam used in initial access. The input from other network devices for the AI/ML model may comprise one or more of: number of Tx/Rx beam/panel, beamforming gain, beam width, location information, transmit power, handover, measurement subset of Tx/Rx beams, scheduling information, beam switch decision, multi-user scheduling decision, traffic status, transmission scheme, wide beam used in initial access. The input from other AI/ML model for the AI/ML model can comprise one or more of: prediction of UE location, prediction of UE trajectory, prediction of handover, predication of initial access, prediction of channel state information (CSI).

In some embodiments, the output from the AI/ML model for the terminal device 110-1 can comprise one or more of: transmit power, beam switch decision, active subset of Tx/Rx beams, transmission scheme. The output from the AI/ML model for the network device 120 can comprise one or more of: transmit power, handover, active subset of Tx/Rx beams, scheduling, beam switch decision, multi-user scheduling decision, traffic status, transmission scheme. The output from the AI/ML model can be as input to other AI/ML model for prediction of UE location/trajectory, prediction of handover/load balancing/energy saving decision, prediction of CSI.

In some embodiments, an additional parameter related to number of reduced UE Rx beams can be used to determine the following when AI/ML model inference is applied: the number of RS resources configured in a RS resource set; measurement period requirement; measurement accuracy requirement. In some embodiments, this parameter can be indicated by the network device 120. Alternatively, this parameter can be reported by the terminal device 110-1. Alternatively, this parameter can be reported by the terminal device 110-1 in capability reporting. In other embodiments, this parameter can also be output of AI/ML model. In this way, it can guide configuration and to set performance requirement when AI/ML model inference is applied. Tables 1-3 show an updated description based on the reduced number receiving beam.

TABLE 1
UE capability reporting ReducedmaxNumberRxBeamForAI INTEGER (1..8)
Defines whether UE supports receive beamforming switching using NZP CSI-RS
resource when AI/ML model inference is applied. UE shall indicate a single value for the
preferred number of NZP CSI-RS resource repetitions per CSI-RS resource set.

```
TABLE 2
T_{L1-RSRP}_{_{—}}_{Measurement}_{_{—}}_{Period}_{_{—}}_{CSI-RS} for CSI-RS, for example, as specified in clause 9.5.4.2 in
3GPP TS 38.133
  - configured with higher layer parameter repetition set to ON
  - with the assumption of M=1 for periodic CSI-RS
      - for aperiodic CSI-RS if number of resources in resource set at least
    equal to MaxNumberRxBeam
      - for aperiodic CSI-RS if number of resources in resource set at least
    equal to ReducedmaxNumberRxBeamForAI when AI/ML model inference is
    applied
  - with T_{Report} = 0
```

TABLE 3
- when AI/ML model inference is applied, for periodic(/semi-persistent) CSI-RS
resources in a resource set configured with higher layer parameter repetition set to ON,
N=ceil(ReducedmaxNumberRxBeamForAI / Nres_per_set), where Nres_per_set is
number of resources in the resource set. The requirements apply provided
qcl-InfoPeriodicCSI-RS is configured with QCL-TypeD for all resources in the resource
set.
- when AI/ML model inference is applied, For aperiodic CSI-RS resources in a resource
set configured with higher layer parameter repetition set to ON, N=1. UE is not required
to meet the accuracy requirements, for example, as specified in clause 10.1.19.2 and
10.1.20.2 in 3GPP TS 38.133, if number of resources in the resource set is smaller than
ReducedmaxNumberRxBeamForAI. The requirements apply provided qcl-info is
configured with QCL-TypeD for all resources in the resource set.

In some other embodiments, the number of occupied CSI processing units (CPUs) and CSI computation time may depend on the number of resources actually measured for beam quality in the first set of resources. For example, the number of occupied CPU can be NCPU (i.e., UE capability on maximum supported number of simultaneous CSI calculations) or K1+1 (i.e., the number of actually measured resources in the resource set, including the target resource). Alternatively, or in addition, the number of occupied CPU can be NCPU or K1 (i.e., the number of actually measured resources in the resource set) for the time span from CSI reference to the last symbol carrying RS in K1. The number of occupied CPU can be 1 for the time span from the first symbol carrying RS for k (i.e., the best resource) to the report. Alternatively, if there are two report configurations for collecting the discrimination information, the number of occupied CPU can be NCPU or K1 for the first report configuration and the number of occupied CPU can be K1+1 for the second report configuration, since the terminal device 110-1 needs to store the results of K1 to compare for the second report. In some embodiments, for the case of DCI triggered CSI report, Z and Z′ can stand for PDCCH to CSI report time and CSI-RS to CSI report time respectively. Dedicated Z and Z′ can be introduced for the report quantity set to a value of requiring input for AI/ML model training, and/or AI/ML model inference. In addition, the exact value can be based on capability reported by the terminal device 110-1.

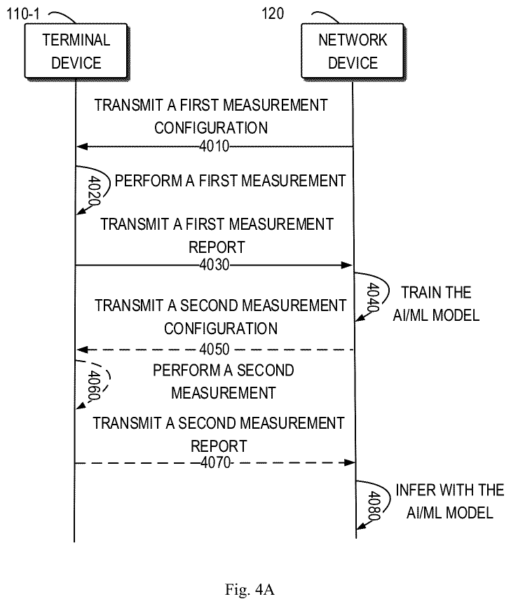

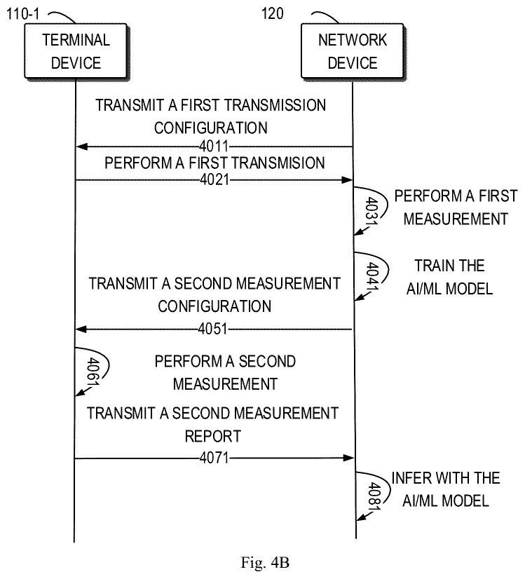

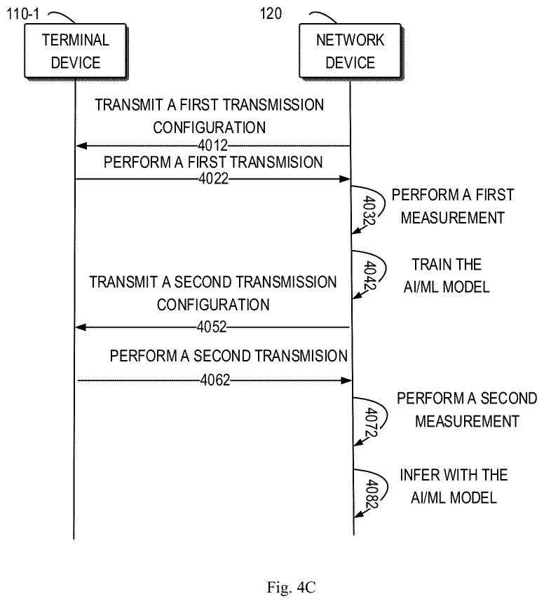

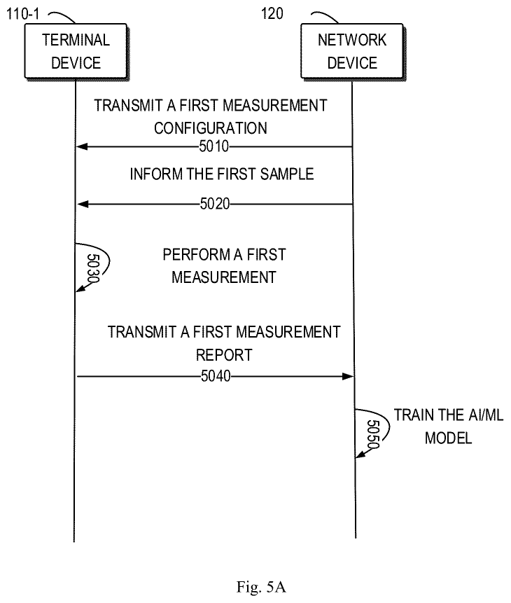

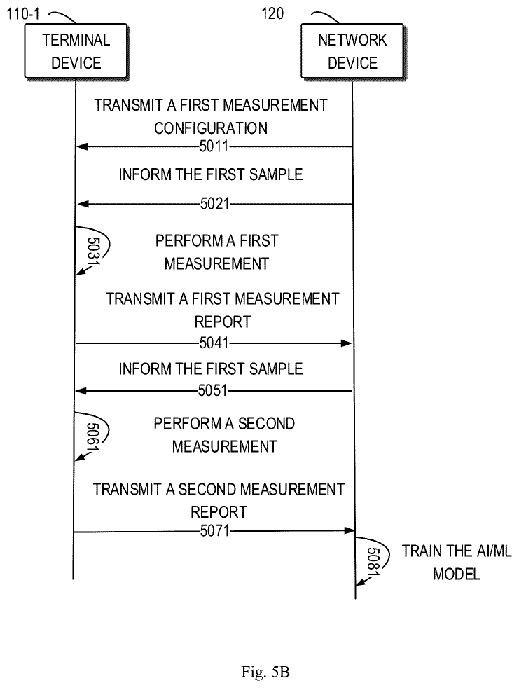

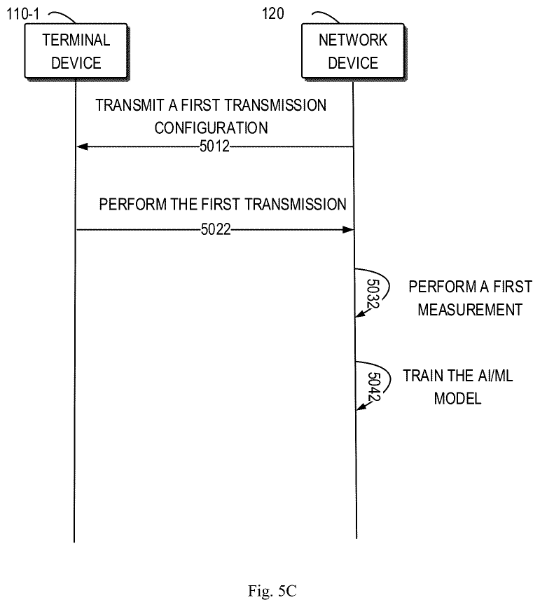

Example embodiments of dataset constructions of the present disclosure are described with reference to FIGS. 4A to 5C.

FIG. 4A shows a signaling chart illustrating process between the terminal device 110-1 and the network device 120 according to some example embodiments of the present disclosure wherein the first configuration is the measurement configuration.

The network device 120 may transmit 4010 a first measurement configuration to the terminal device 110-1. The first measurement configuration may indicate resources for measurements. In some embodiments, the first measurement configuration may indicate indexes of the resources for measurement. In this case, for example, the first measurement configuration may comprise synchronization signal/physical broadcast channel block index. Alternatively, the first measurement configuration may comprise a channel state information (CSI) reference signal (RS) resource index. The first measurement configuration may indicate the terminal device 110-1 to perform the measurements on all resources. In other words, the network device 120 can acquire the information about a full set of beam pairs and beam qualities.

In some embodiments, the first measurement configuration can comprise the report configuration for model training (ReportConfigForModelTraining). In addition, the first measurement configuration can comprise resource configuration for model training (ResourceConfigForModelTraining).

The terminal device 110-1 may perform 4020 a first measurement based on the first measurement configuration. The terminal device 110-1 can perform the first measurement on the resources. The terminal device 110-1 may determine qualities on the resources based on results of the first measurement. For example, the terminal device 110-1 may determine RSRP on the resources. Alternatively, the terminal device 110-1 may determine SINR on the resources.

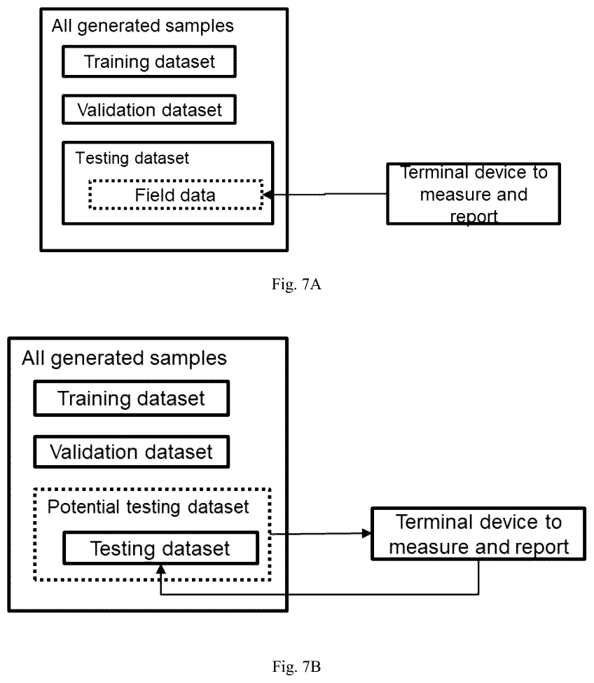

The terminal device 110-1 may transmit 4030 a first measurement report to the network device 120. The first measurement report may comprise indexes of the resources and their qualities. For example, the first measurement report can comprise K beam pairs and their qualities, for example, K SSBRI/CRI+K LI-RSRP. The number of resources in the first measurement report can be based on the number of beams at the network device 120 and the number of beams at the terminal device 110-1. FIG. 6A shows one data sample reported by the terminal device 110-1 based on results of the first measurement. As shown in FIG. 6A, the first measurement report comprises the full set of beam pairs and their RSRPs. The number of rows in FIG. 6A corresponds to the number of UE receiving beam. The number of columns in FIG. 6A corresponds to the number of network transmitting beams. Each element in FIG. 6A corresponds to one resource. As shown in FIG. 7A, measurement results (i.e., reported qualities of the resources) in the first measurement report may be as a part of samples in the testing dataset. Similarly, the measurement results may also be as a part of samples in the training dataset or the validation dataset.

In some embodiments, the terminal device 110-1 may not report the indexes of the resources. In this case, the RSRPs of the resources can be sorted in the first measurement report according to ascending/descending order of indexes of the resources. Alternatively or in addition, the terminal device 110-1 may not report the resource with poor quality. For example, if one resource has a RSRP lower than a threshold RSRP, the terminal device 110-1 may not report the index of such resource in the first measurement report. In other embodiments, the terminal device 110-1 may not report receiving beam information. For example, the terminal device 110-1 may only report information about transmitting beam, assuming each transmitting beam is measured via its best-match UE receiving beam. In some embodiments, the AI/ML model is restricted per the wide beam pair identified in the initial access phase. In some other embodiments, the network device 120 may transmit reference qualities of the resources to the terminal device 110-1. In this case, the terminal device 110-1 may transmit the first measurement report comprising difference qualities of the first set of resources with respect to reference qualities. For example, the network device 120 may transmit a map of (RS ID+RSRP) to the terminal device 110-1. In this case, the terminal device 110-1 may feedback a differential map with respect to NW's version. More specifically, he network device 120 may transmit (RSRP₁, RSRP₂, . . . , RSRP_{K}), the terminal device 110-1 may feedback (ΔRSRP₁, ΔRSRP₂, . . . , ΔRSRP_{K})=(R̅S̅R̅P̅1̅, R̅S̅R̅P̅2̅, . . . , R̅S̅R̅P̅1̅K̅)−(RSRP₁, RSRP₂, . . . , RSRP_{K}), by measuring RS and calculating the difference for ID 1 to K respectively. Within the map (RSRP₁, RSRP₂, . . . , RSRP_{K}) and (ΔRSRP₁, ΔRSRP₂, . . . , ΔRSRP_{K}), further differential quantization can be used. In this way, the overhead of the first report can be reduced.

The network device 120 may train 4040 the AI/ML model based on the results of the measurement. In some embodiments, the output of the AI/ML model may recover all resources and all RSRPs. Alternatively, the output of the AI/ML model may the best resource/beam and the RSRP of the best resource. Referring to FIG. 6B, the input of the AI/ML model can be the subset of resources K1 and the corresponding RSRPs and the output of the AI/ML model can recover all resources/beams and their RSRPs.

Alternatively, referring to FIG. 6C, the input of the AI/ML model can be the subset of resources K1 and the corresponding RSRPs and the output of the AI/ML model can be the best beam k in set K which maximizes RSRP. In this way, the AI/ML model can be optimized based on real measurement results, thereby obtaining a more accurate AI/ML model fitting the practical scenarios.

In some embodiments, the network device 120 may transmit 4050 a second measurement configuration to the terminal device 110-1. The second measurement configuration may indicate resources for the second measurement. In some embodiments, the second measurement configuration may indicate indexes of the resources for the second measurement. In this case, for example, the second measurement configuration may comprise SSB index. Alternatively, the second measurement configuration may comprise a CSI-RS resource index.

The terminal device 110-1 may perform 4060 a second measurement based on the second measurement configuration. The terminal device 110-1 can perform the second measurement on the resources. The terminal device 110-1 may determine qualities on the resources based on results of the second measurement. For example, the terminal device 110-1 may determine RSRP on the resources. Alternatively, the terminal device 110-1 may determine SINR on the resources.

The terminal device 110-1 may transmit 4070 a second measurement report to the network device 120. The second measurement report may comprise indexes of the resources and their qualities. The second measurement report can be used as inference data for real-time UE beam management.

The network device 120 may infer 4080 with the AI/ML model based on the second measurement report. In other words, the network device 120 may perform model inference according to the AI/ML model. For example, the AI/ML model can output the prediction, including e.g., the full set of beam pairs and beam qualities, the best beam for subsequent transmission, the updated subset for second measurement.

FIG. 4B shows a signaling chart illustrating process between the terminal device 110-1 and the network device 120 according to some example embodiments of the present disclosure wherein the first configuration is the transmission configuration.

The network device 120 may transmit 4011 a first transmission configuration to the terminal device 110-1. The first transmission configuration may indicate resources for transmitting sounding reference signals. In some embodiments, the first transmission configuration may indicate indexes of the resources for transmitting sounding reference signals. The first transmission configuration may indicate the terminal device 110-1 to perform the transmissions on all resources. In some embodiments, the first transmission configuration can comprise an information element “SRS resource set usage” indicating that the resources are used for training AI/ML model.

The terminal device 110-1 may perform 4021 a first transmission based on the first transmission configuration. The terminal device 110-1 can transmit sounding reference signals on the resources based on the first transmission configuration. In this way, it does not add extra burden on the terminal device 110-1.

The network device 120 may perform 4031 a first measurement based on the sounding reference signals. The network device 120 may determine qualities on the received sounding reference signals. For example, the network device 120 may determine RSRP of the received sounding reference signals. Alternatively, network device 120 may determine SINR of the received sounding reference signals. As shown in FIG. 7A, measurement results (i.e., measured qualities of the resources) in the first measurement report may be as a part of samples in the testing dataset. Similarly, the measurement results may also be as a part of samples in the training dataset or the validation dataset.

The network device 120 may train 4041 the AI/ML model based on the results of the first measurement. In some embodiments, the output of the AI/ML model may recover all resources and all RSRPs. Alternatively, the output of the AI/ML model may the best resource/beam and the RSRP of the beast resource. In this way, the AI/ML model can be optimized based on real measurement results.

In some embodiments, the network device 120 may transmit 4051 a second measurement configuration to the terminal device 110-1. The second measurement configuration may indicate resources for the second measurement. In some embodiments, the second measurement configuration may indicate indexes of the resources for the second measurement. In this case, for example, the second measurement configuration may comprise SSB index. Alternatively, the second measurement configuration may comprise a CSI-RS resource index.

The terminal device 110-1 may perform 4061 a second measurement based on the second measurement configuration. The terminal device 110-1 can perform the second measurement on the resources. The terminal device 110-1 may determine qualities on the resources based on results of the second measurement. For example, the terminal device 110-1 may determine RSRP on the resources. Alternatively, the terminal device 110-1 may determine SINR on the resources.

The terminal device 110-1 may transmit 4071 a second measurement report to the network device 120. The second measurement report may comprise indexes of the resources and their qualities. The second measurement report can be used as inference data for real-time UE beam management.

The network device 120 may infer 4081 with the AI/ML model based on the second measurement report. In other words, the network device 120 may perform model inference according to the AI/ML model. For example, the AI/ML model can output the prediction, including e.g., the full set of beam pairs and beam qualities, the best beam for subsequent transmission, the subset for second measurement.

FIG. 4C shows a signaling chart illustrating process between the terminal device 110-1 and the network device 120 according to some example embodiments of the present disclosure wherein the first configuration is the transmission configuration.

The network device 120 may transmit 4012 a first transmission configuration to the terminal device 110-1. The first transmission configuration may indicate resources for transmitting sounding reference signals. In some embodiments, the first transmission configuration may indicate indexes of the resources for transmitting sounding reference signals. The first transmission configuration may indicate the terminal device 110-1 to perform the transmissions on all resources. In some embodiments, the first transmission configuration can comprise an information element “SRS resource set usage” indicating that the resources are used for training AI/ML model.

The terminal device 110-1 may perform 4022 a first transmission based on the first transmission configuration. The terminal device 110-1 can transmit sounding reference signals on the resources based on the first transmission configuration. In this way, it does not add extra burden on the terminal device 110-1.

The network device 120 may perform 4032 a first measurement based on the sounding reference signals. The network device 120 may determine qualities on the received sounding reference signals. For example, the network device 120 may determine RSRP of the received sounding reference signals. Alternatively, network device 120 may determine SINR of the received sounding reference signals. As shown in FIG. 7A, measurement results (i.e., measured qualities of the resources) in the first measurement report may be as a part of samples in the testing dataset. Similarly, the measurement results may also be as a part of samples in the training dataset or the validation dataset.

The network device 120 may train 4042 the AI/ML model based on the results of the first measurement. In some embodiments, the output of the AI/ML model may recover all resources and all RSRPs. Alternatively, the output of the AI/ML model may the best resource/beam and the RSRP of the beast resource. In this way, the AI/ML model can be optimized based on real measurement results.

The network device 120 may transmit 4052 a second transmission configuration to the terminal device 110-1. The second transmission configuration may indicate resources for transmitting sounding reference signals. In some embodiments, the second transmission configuration may indicate indexes of the resources for transmitting sounding reference signals. In some embodiments, the second transmission configuration can comprise an information element “SRS resource set usage” indicating that the resources are used for inferring AI/ML model.

The terminal device 110-1 may perform 4062 a second transmission based on the second transmission configuration. The terminal device 110-1 can transmit sounding reference signals on the resources based on the second transmission configuration.

The network device 120 may perform 4072 a second measurement based on the sounding reference signals. The network device 120 may determine qualities on the received sounding reference signals. For example, the network device 120 may determine RSRP of the received sounding reference signals. Alternatively, network device 120 may determine SINR of the received sounding reference signals.

The network device 120 may infer 4082 with the AI/ML model based on the results of the second measurement. In other words, the network device 120 may perform model inference according to the AI/ML model. For example, the AI/ML model can output the prediction, including e.g., the full set of beam pairs and beam qualities, the best beam for subsequent transmission, the subset for second measurement.

According to some embodiments, the terminal device 110-1 can be used as a discriminator to discriminate the data sample for training generated by the network device 120. The terminal device 110-1 may transmit the discrimination result to the network device 120. Embodiments are described with reference to FIGS. 5A-5C where the terminal device 110-1 acts as the discriminator.

FIG. 5A shows a signaling chart illustrating process between the terminal device 110-1 and the network device 120 according to some example embodiments of the present disclosure wherein the first configuration is the measurement configuration.

The network device 120 may transmit 5010 a first measurement configuration to the terminal device 110-1. The first measurement configuration may indicate a subset of resources for measurements.

The network device 120 may inform 5020 a first candidate data sample for constructing the first dataset to the terminal device 110-1. In some embodiments, the first candidate data sample may comprise a subset of resources as input of the AI/ML model and a target resource as output of the AI/ML model. As shown in FIG. 7B, the potential data samples for training the AI/ML model can be sent to the terminal device 110-1 and measured by the terminal device 110-1.

The first candidate data sample can be indicated to the terminal device 110-1 via proper signaling. For example, the first candidate data sample can be indicated via radio resource control (RRC) signaling. Alternatively, the first candidate data sample can be indicated in a medium access control (MAC) control element (CE). In some other embodiments, the first candidate data sample can be indicated in downlink control information (DCI). In some embodiments, the first measurement configuration may comprise the first candidate data sample for constructing the first dataset.

In some embodiments, the ‘RS-subset-to-measure-for-training’ and ‘RS-to-compare-for-training’ RRC IE can be used to indicate the first candidate data sample. The size of RS-subset-to-measure-for-training can depend on the number of beams at NW side, the number of beams at UE side. In addition, a time offset can be configured between the last symbol carrying RS in the subset of resources/beams K1 and the first symbol carrying RS for the target resource/beam \hat{k}. The added IE to indicate the subset K1 of resources to be measured, can be bit string (01 . . . 01), while 1 implies to measure and 0 for not to measure, the length of bit string equals to the number of resources in a resource sets. Alternatively or in addition, the added IE to indicate the predicted best beam/resource \hat{k} can be an index or identity of the beam/resource.

In addition, the first measurement configuration may comprise a report configuration for terminal device 110-1. The terminal device 110-1 can determine which report quantity to report to the network device 120 based on the report configuration. In some embodiments, the first report quantity may indicate whether the first candidate data sample is suitable for constructing the first dataset for the AI/ML model. Alternatively, the first report quantity may indicate a result of the comparison between the qualities of the subset of resources and the quality of the target resource.

The terminal device 110-1 may perform 5030 a first measurement based on the first measurement configuration. For example, the terminal device 110-1 may perform the first measurement on the subset of resources. The terminal device 110-1 may determine qualities of the subset of resources based on the first measurement on the subset of resources. For example, the terminal device 110-1 may determine RSRP on the subset of resources. Alternatively, the terminal device 110-1 may determine SINR on the one subset of resources.

The terminal device 110-1 may also perform the first measurement on the target resource. The terminal device 110-1 may determine a quality of the target resource based on the first measurement on the target resource. For example, the terminal device 110-1 may determine RSRP on the target resource. Alternatively, the terminal device 110-1 may determine SINR on the target resource.

The terminal device 110-1 may transmit 5040 a first measurement report to the network device 120. The first measurement report may comprise the first report quantity. In some embodiments, the first report quantity may indicate the discrimination result which indicates whether the first candidate data sample is suitable for constructing the first dataset for the AI/ML model. In some embodiments, the first report quantity may indicate whether the first candidate data sample is suitable for constructing the first dataset for the AI/ML model. Alternatively, the first report quantity may indicate a result of the comparison between the qualities of the subset of resources and the quality of the target resource. For example, the terminal device 110-1 may compare the qualities of the subset of resources with the quality of the target resource. In this case, if at least one quality of the subset of resources is better than the quality of the target resource, the first report quantity may indicate that the first candidate data sample is not suitable constructing the first dataset for the AI/ML model. For example, if at least one RSRPs of K1 RSs is larger RSRP of \hat{k}, the first candidate data sample is not suitable. In this case, the first report quantity may be 0. Alternatively, if the quality of the target resource is better than all qualities of the subset of resources, the first report quantity may indicate that the first candidate data sample is suitable constructing the first dataset for the AI/ML model. For example, if all RSRPs of K1 RSs is smaller than RSRP of \hat{k}, the first candidate data sample is not suitable. In this case, the first report quantity may be 1. In some embodiments, a comparison offset can be applied. For example, a RSRP offset can be added in left or right hand side of the inequality: all RSRPs of K1 RSs<RSRP \hat{k}. Alternatively or in addition, a time offset can be added in left or right hand side of the inequality: all RSRPs of K1 RSs (@time n−T)<RSRP \hat{k} (@time n). The unit of time can be any suitable type without restrictions, e.g., TTI, frame, subframe, slot, symbol, second, millisecond, etc.

In some embodiments, the first measurement report may comprise 1 bit for one candidate data sample or N bits for N candidate data samples. Alternatively, the first measurement report may comprise 1 bit for N candidate data samples. The bit width for the resource indexes can be ceil (log 2 (K1+1)) or ceil (log 2 (K1)) or 0, wherein K1 represents the number of resources in the subset of resources.

In some embodiments, the first report quantity may comprise indexes of the resources and the qualities of the resources. For example, the first report quantity may comprise a first index of the target resource and the quality of the target resource. Alternatively or in addition, the first report quantity may comprise indexes of the subset of resources and the qualities of the subset of resources. In other embodiments, the first report quantity may comprise the first index of the target resource with the quality of the target resource and the indexes of the subset of resources with the qualities of the subset of resources. Only as an example, the first report quantity can comprise the SSBRI/CRI of the target resource, the RSRP/SINR of the target resource. Alternatively or in addition, the first report quantity may also comprise the SSBRIs/CRIs of the subset of resources and the RSRPs/SINRs of the subset of resources. In this way, the overhead can be reduced.

Alternatively, the first report quantity may comprise a second index of a best resource determined by the terminal device 110-1. For example, the first report quantity may comprise the SSBRI/CRI of the best resource. In this case, the terminal device 110-1 can recommend the best resource or best beam. In some embodiments, the first report quantity may comprise indexes of a subset of measurement resources determined by the terminal device 110-1. For example, the first report quantity may comprise the SSBRIs/CRIs of the subset of measurement resources. In this case, the terminal device 110-1 can recommend the measured resources or beams. In other embodiments, the first report quantity may comprise the second index of the best resource and the indexes of the subset of measurement resources determined by the terminal device 110-1.

In some embodiments, the first report quantity may the qualities of the resources. For example, the first report quantity may comprise the quality of the best resource/beam. Only as an example, the first report quantity may comprise the RSRP or SINR of the best resource/beam. Alternatively, the first report quantity may the qualities of the subset of measurement resources/beams. In this case, the qualities of the subset of measurement resources/beams can be sorted in order of ascending or descending indexes of the resources. In this way, the overhead of the first report can be reduced.

The network device 120 may train 5050 the AI/ML model based on the first measurement report. In some embodiments, if the first measurement report indicates that the first candidate data sample is not suitable for constructing the data set, the network device 120 may not use the first candidate data sample for training the AI/ML model. Alternatively, if the first measurement report indicates that the first candidate data sample is suitable for constructing the data set, the network device 120 may use the first candidate data sample for training the AI/ML model. As shown in FIG. 7B, the network device 120 may construct the testing data set based on the discrimination results in the first measurement report.

FIG. 5B shows a signaling chart illustrating process between the terminal device 110-1 and the network device 120 according to some example embodiments of the present disclosure wherein the first configuration is the transmission configuration.

The network device 120 may transmit 5011 a first measurement configuration to the terminal device 110-1. The first measurement configuration may indicate a subset of resources for measurements. The first measurement configuration may comprise two related report configurations. For example, the first measurement configuration may comprise a first report configuration with resources in K1 and a second report configuration with resource for k. The two report configurations can be linked with each other. In addition, a time offset can be configured between the two reports or between resources associated with two report configurations.

The network device 120 may inform 5021 a first candidate data sample for constructing the first dataset to the terminal device 110-1. In some embodiments, the first candidate data sample may comprise a subset of resources as input of the AI/ML model. As shown in FIG. 7B, the potential data samples for training the AI/ML model can be sent to the terminal device 110-1 and measured by the terminal device 110-1. The network device 120 may transmit reference signals on the subset of resources.

The first candidate data sample can be indicated to the terminal device 110-1 via proper signaling. For example, the first candidate data sample can be indicated via radio resource control (RRC) signaling. Alternatively, the first candidate data sample can be indicated in a medium access control (MAC) control element (CE). In some other embodiments, the first candidate data sample can be indicated in downlink control information (DCI). In some embodiments, the first measurement configuration may comprise the first candidate data sample for constructing the first dataset.

In some embodiments, the ‘RS-subset-to-measure-for-training’ RRC IE can be used to indicate the first candidate data sample. The size of RS-subset-to-measure-for-training can depend on the number of beams at NW side, the number of beams at UE side. The added IE to indicate the subset K1 of resources to be measured, can be bit string (01 . . . 01), while 1 implies to measure and 0 for not to measure, the length of bit string equals to the number of resources in a resource sets. In addition, a time offset can be configured between the last symbol carrying RS in the subset of resources/beams K1 and the first symbol carrying RS for the target resource/beam \hat{k}.

The terminal device 110-1 may perform 5031 a first measurement based on the first measurement configuration. For example, the terminal device 110-1 may perform the first measurement on the subset of resources. The terminal device 110-1 may determine qualities of the subset of resources based on the first measurement on the subset of resources. For example, the terminal device 110-1 may determine RSRP on the subset of resources. Alternatively, the terminal device 110-1 may determine SINR on the subset of resources.

The terminal device 110-1 may transmit 5041 a first measurement report to the network device 120. In some embodiments, the first report quantity may the qualities of the resources. For example, the first report quantity may the qualities of the subset of measurement resources/beams. In this case, the qualities of the subset of measurement resources/beams can be sorted in order of ascending or descending indexes of the resources. In this way, the overhead of the first report can be reduced.

In some embodiments, the first report quantity may comprise indexes of the resources and the qualities of the resources. For example, the first report quantity may comprise indexes of the subset of resources and the qualities of the subset of resources. For example, the first report quantity may also comprise the SSBRIs/CRIs of the subset of resources and the RSRPs/SINRs of the subset of resources. In this way, the network device determines whether the target resource has the best quality.

The network device 120 may inform 5051 a target resource to the terminal device 110-1. The network device 120 may transmit a reference signal on the target resource. The target resource can be indicated to the terminal device 110-1 via proper signaling. For example, the target resource can be indicated via radio resource control (RRC) signaling. Alternatively, the target resource can be indicated in a medium access control (MAC) control element (CE). In some other embodiments, the target resource can be indicated in downlink control information (DCI).

In some embodiments, the ‘RS-to-compare-for-training’ RRC IE can be used to indicate the first candidate data sample. Alternatively or in addition, the added IE to indicate the predicted best beam/resource I can be an index or identity of the beam/resource.

In some embodiments, the first measurement report may comprise 1 bit for one candidate data sample or N bits for N candidate data samples. Alternatively, the first measurement report may comprise 1 bit for N candidate data samples. The bit width for the resource indexes can be ceil (log 2(K1+1)) or ceil (log 2(K1)) or 0, wherein K1 represents the number of resources in the subset of resources.

The terminal device 110-1 may perform 5061 a second measurement on the target resource. For example, the terminal device 110-1 may determine RSRP on the target resource. Alternatively, the terminal device 110-1 may determine SINR on the target resource.

The terminal device 110-1 may transmit 5071 a second measurement report to the network device 120. The second measurement report may comprise the quality of the target resource. For example, the second measurement report may comprise the RSRP of the target resource.

Alternatively or in addition, the second measurement report may comprise the first report quantity. In some embodiments, the first report quantity may indicate whether the first candidate data sample is suitable for constructing the first dataset for the AI/ML model. For example, the terminal device 110-1 may compare the qualities of the subset of resources with the quality of the target resource. In this case, if at least one quality of the subset of resources is better than the quality of the target resource, the first report quantity may indicate that the first candidate data sample is not suitable constructing the first dataset for the AI/ML model. Alternatively, if the quality of the target resource is better than all qualities of the subset of resources, the first report quantity may indicate that the first candidate data sample is suitable constructing the first dataset for the AI/ML model. In some embodiments, a comparison offset can be applied. For example, a RSRP offset can be added in left or right hand side of the inequality: all RSRPs of K1 RSs<RSRP \hat{k}. Alternatively, a time offset can be added in left or right hand side of the inequality: all RSRPs of K1 RSs (@time n−T)<RSRP Å (@time n).

The network device 120 may train 5081 the AI/ML model based on the second measurement report. In some embodiments, if the second measurement report indicates that the first candidate data sample is not suitable for constructing the data set, the network device 120 may not use the first candidate data sample for training the AI/ML model. Alternatively, if the second measurement report indicates that the first candidate data sample is suitable for constructing the data set, the network device 120 may use the first candidate data sample for training the AI/ML model. As shown in FIG. 7B, the network device 120 may construct the testing data set based on the discrimination results in the first measurement report.

FIG. 5C shows a signaling chart illustrating process between the terminal device 110-1 and the network device 120 according to some example embodiments of the present disclosure wherein the first configuration is the transmission configuration.

The network device 120 may transmit 5012 a first transmission configuration to the terminal device 110-1. The first transmission configuration may indicate a subset of resources for transmitting sounding reference signals. In some embodiments, the first transmission configuration may indicate indexes of the subset of resources for transmitting sounding reference signals. Alternatively, the first transmission configuration may indicate an index of a target resource.

The subset of resources can be indicated to the terminal device 110-1 via proper signaling. For example, the subset of resources can be indicated via radio resource control (RRC) signaling. For example, RRC IE ‘RS-subset-to-transmit-for-training’ and ‘RS-to-compare-for-training’ can be added to the RRC signaling. Alternatively, the subset of resources can be indicated in a medium access control (MAC) control element (CE). In some other embodiments, the subset of resources can be indicated in downlink control information (DCI). In addition, a time offset can be configured between the last symbol carrying RS in the subset of resources/beams K1 and the first symbol carrying RS for the target resource/beam \hat{k}.

The terminal device 110-1 may perform 5022 a first transmission based on the first transmission configuration. The terminal device 110-1 can transmit sounding reference signals on the subset of resources based on the first transmission configuration. In some embodiments, the terminal device 110-1 may also transmit a sounding reference signal on the target resource. In this way, it does not add extra burden on the terminal device 110-1.

In some other embodiments, the network device 120 may transmit a second transmission configuration to the terminal device 110-1. The second transmission configuration may indicate the index of the target resource.

The network device 120 may perform 5032 a first measurement based on the sounding reference signals. The network device 120 may determine qualities on the sounding reference signals received on the subset of resources. For example, the network device 120 may determine RSRP of the received sounding reference signals. Alternatively, network device 120 may determine SINR of the received sounding reference signals. In some embodiments, the network device 120 may determine the quality on the sounding reference signal received on the target resource.

The network device 120 may train 5042 the AI/ML model based on the measurement results. In some embodiments, if the measurement results indicates that the quality on the target resource is better than the qualities on the subset of resource, the network device 120 may use the first candidate data sample which comprise a subset of resources as input of the AI/ML model and a target resource as output of the AI/ML model, for training the AI/ML model. Alternatively, if the measurement results indicate that at least one resource in the subset of resources has a better quality than the target resource, the network device 120 may not use the first candidate data sample for training the AI/ML model.

It should be noted that embodiments described above can be implemented separately. Alternatively, embodiments described above can be implemented in any proper combinations.

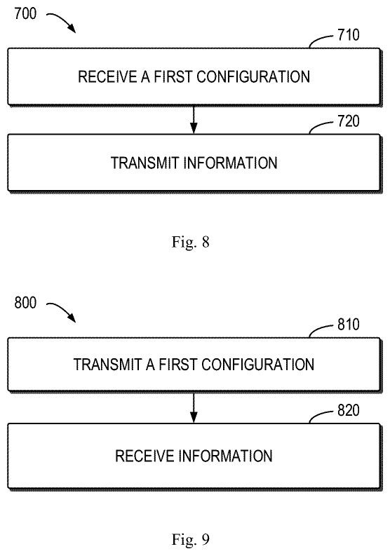

FIG. 8 shows a flowchart of an example method 700 in accordance with an embodiment of the present disclosure. The method 700 can be implemented at any suitable devices. Only for the purpose of illustrations, the method 700 can be implemented at a terminal device 110-1 as shown in FIG. 1.

At block 710, the terminal device 110-1 receives a first configuration from the network device 120. The first configuration indicates at least one subset of resources from a first set of resources. In some embodiments, the first set of resources may comprise resources for beam measurement and report. The at least one subset of resource is for constructing a first dataset for training the AI/ML model 200 at the network device 120. The first dataset comprises one or more of: a training dataset for model training, a validation dataset for model training, a test dataset for model training, or a dataset for model inference.

In some embodiments, the first configuration may be the first measurement configuration. In this case, the terminal device 110-1 may perform the measurement on the at least one subset of resources based on the first measurement configuration. For example, the first configuration may indicate a first candidate data sample for constructing the first dataset. The first candidate data sample may comprise a subset of resources as input of the AI/ML model and a target resource as output of the AI/ML model. Alternatively, the first configuration may indicate the terminal device 110-1 to perform measurements on the first set of resources. In some embodiments, the terminal device 110-1 may determine qualities based on results of the measurement. For example, the terminal device 110-1 may determine reference signal received power (RSRP) based on the measurement. Alternatively, the terminal device 110-1 may determine signal plus interference to noise ratio (SINR) based on the measurement.

In other embodiments, the first configuration may be the first transmission configuration. In this case, the terminal device may perform transmissions based on the first transmission configuration. For example, the first configuration may indicate a set of reference signal resources for sounding reference signal (SRS). Alternatively or in addition, the first configuration may indicate a subset of reference signal resources from the set of reference signal resources. In other embodiments, the first configuration may indicate a target reference signal resource.

At block 720, the terminal device 110-1 transmits information to the network device 120. In some embodiments, if the first configuration is the first measurement configuration, the terminal device 110-1 may transmit results of the measurement to the network device 120. Alternatively, if the first configuration is the first transmission configuration, the terminal device 110-1 may transmit sounding reference signals to the network device 120. In this case, the network device 120 can measure the sounding reference signals.

In some embodiments, the terminal device 110-1 may receive an indication of an updated subset of resources from the network device 120. In some embodiments, the updated subset of resources can be the input of AI/ML model training. Alternatively or in addition, the updated subset of resources can be used for collecting data for AI/ML model training. In other embodiments, the updated subset of resources can be used for collecting data for AI/ML model inference. In some other embodiments, the updated subset of resources can be used for normal beam measurement and report. In this way, it can avoid randomly selected measurement subset.

In some embodiments, explicit signaling may be needed to inform the terminal device 110-1 about the updated measurement subset K1. For example, the input of the AI/ML model training can be updated based on the updated subset of resources. In other embodiments, the updated subset of resources can be transmitted in the first measurement configuration, which means that the configuration for collecting data for AI/ML model training can be updated. In this case, the RRC IE ‘RS-subset-to-measure-for-training’ and ‘RS-to-compare-for-training’ can be used for informing the updated subset of resources. Alternatively, the updated subset of resources can be transmitted in the second measurement configuration, which means that the configuration for collecting data for AI/ML model inference can be updated. In this case, a new signaling ‘RS-subset-measure-for-inference’ can be used for informing the updated subset of resources. As mentioned above, different AI/ML models can be used for different subset K1 selection. In other words, multiple AI/ML models (model i) can be learning how to generate K from different version of K1_i. In this case, instead of using K1′ as the output, the AI/ML model ID i can be used as output if one version of K1 selection corresponds one AI/ML model.

In some embodiments, the input from the terminal device 110-1 for the first AI/ML mode can comprise one or more of: number of Tx/Rx beam/panel, beamforming gain, beam width, location information, trajectory, velocity, orientation, moving direction, transmit power, measurement subset of Tx/Rx beams, transmission scheme, wide beam used in initial access. The input from the network device 120 for the AI/ML model can comprise one or more of: number of Tx/Rx beam/panel, beamforming gain, beam width, location information, transmit power, handover, measurement subset of Tx/Rx beams, scheduling information, beam switch decision, multi-user scheduling decision, traffic status, transmission scheme, wide beam used in initial access. The input from other terminal devices for the AI/ML model can comprise one or more of: number of Tx/Rx beam/panel, beamforming gain, beam width, location information, trajectory, velocity, orientation, moving direction, transmit power, measurement subset of Tx/Rx beams, transmission scheme, wide beam used in initial access. The input from other network devices for the AI/ML model may comprise one or more of: number of Tx/Rx beam/panel, beamforming gain, beam width, location information, transmit power, handover, measurement subset of Tx/Rx beams, scheduling information, beam switch decision, multi-user scheduling decision, traffic status, transmission scheme, wide beam used in initial access. The input from other AI/ML model for the AI/ML model can comprise one or more of: prediction of UE location, prediction of UE trajectory, prediction of handover, predication of initial access, prediction of channel state information (CSI).

In some embodiments, the output from the AI/ML model for the terminal device 110-1 can comprise one or more of: transmit power, beam switch decision, active subset of Tx/Rx beams, transmission scheme. The output from the AI/ML model for the network device 120 can comprise one or more of: transmit power, handover, active subset of Tx/Rx beams, scheduling, beam switch decision, multi-user scheduling decision, traffic status, transmission scheme. The output from the AI/ML model can be as input to other AI/ML model for prediction of UE location/trajectory, prediction of handover/load balancing/energy saving decision, prediction of CSI.

In some embodiments, an additional parameter related to number of reduced UE Rx beams can be used to determine the following when AI/ML model inference is applied: the number of RS resources configured in a RS resource set; measurement period requirement; measurement accuracy requirement. In some embodiments, this parameter can be indicated by the network device 120. Alternatively, this parameter can be reported by the terminal device 110-1. Alternatively, this parameter can be reported by the terminal device 110-1 in capability reporting. In other embodiments, this parameter can also be output of AI/ML model. In this way, it can guide configuration and to set performance requirement when AI/ML model inference is applied.

In some embodiments, the number of occupied CSI processing units (CPUs) and CSI computation time may depend on the number of resources actually measured for beam quality in the first set of resources. For example, the number of occupied CPU can be NCPU (i.e., UE capability on maximum supported number of simultaneous CSI calculations) or K1+1 (i.e., the number of actually measured resources in the resource set, including the target resource). Alternatively, or in addition, the number of occupied CPU can be NCPU or K1 (i.e., the number of actually measured resources in the resource set) for the time span from CSI reference to the last symbol carrying RS in K1. The number of occupied CPU can be 1 for the time span from the first symbol carrying RS for k (i.e., the best resource) to the report. Alternatively, if there are two report configurations for collecting the discrimination information, the number of occupied CPU can be NCPU or K1 for the first report configuration and the number of occupied CPU can be K1+1 for the second report configuration, since the terminal device 110-1 needs to store the results of K1 to compare for the second report. In some embodiments, for the case of DCI triggered CSI report, Z and Z′ can stand for PDCCH to CSI report time and CSI-RS to CSI report time respectively. Dedicated Z and Z′ can be introduced for the report quantity set to a value of requiring input for AI/ML model training, and/or AI/ML model inference. In addition, the exact value can be based on capability reported by the terminal device 110-1.

FIG. 9 shows a flowchart of an example method 800 in accordance with an embodiment of the present disclosure. The method 800 can be implemented at any suitable devices. Only for the purpose of illustrations, the method 800 can be implemented at a network device 120 as shown in FIG. 1.

At block 810, the network device 120 transmits a first configuration to the terminal device 110-1. The first configuration indicates at least one subset of resources from a first set of resources. In some embodiments, the first set of resources may comprise resources for beam measurement and report. The at least one subset of resource is for constructing a first dataset for training the AI/ML model 200 at the network device 120. The first dataset comprises one or more of: a training dataset for model training, a validation dataset for model training, a test dataset for model training, or a dataset for model inference.

In some embodiments, the first configuration may be the first measurement configuration. In this case, the terminal device 110-1 may perform the measurement on the at least one subset of resources based on the first measurement configuration. For example, the first configuration may indicate a first candidate data sample for constructing the first dataset. The first candidate data sample may comprise a subset of resources as input of the AI/ML model and a target resource as output of the AI/ML model. Alternatively, the first configuration may indicate the terminal device 110-1 to perform measurements on the first set of resources. In some embodiments, the terminal device 110-1 may determine qualities based on results of the measurement. For example, the terminal device 110-1 may determine reference signal received power (RSRP) based on the measurement. Alternatively, the terminal device 110-1 may determine signal plus interference to noise ratio (SINR) based on the measurement.

In other embodiments, the first configuration may be the first transmission configuration. In this case, the terminal device may perform transmissions based on the first transmission configuration. For example, the first configuration may indicate a set of reference signal resources for sounding reference signal (SRS). Alternatively or in addition, the first configuration may indicate a subset of reference signal resources from the set of reference signal resources. In other embodiments, the first configuration may indicate a target reference signal resource.

At block 830, the network device 120 receives information from the terminal device 110-1. In some embodiments, if the first configuration is the first measurement configuration, the terminal device 110-1 may transmit results of the measurement to the network device 120. Alternatively, if the first configuration is the first transmission configuration, the terminal device 110-1 may transmit sounding reference signals to the network device 120. In this case, the network device 120 can measure the sounding reference signals.

In some embodiments, the network device 120 may train the AI/ML model. The network device 120 may construct the first dataset based on the result of the measurements. The AI/ML model can be trained based on the first dataset. In this way, the AI/ML model can be optimized based on real measurement results.

The network device 120 may transmit an indication of an updated subset of resources to the terminal device 110-1. In some embodiments, the updated subset of resources can be the input of AI/ML model training. Alternatively or in addition, the updated subset of resources can be used for collecting data for AI/ML model training. In other embodiments, the updated subset of resources can be used for collecting data for AI/ML model inference. In some other embodiments, the updated subset of resources can be used for normal beam measurement and report. In this way, it can avoid randomly selected measurement subset.

In some embodiments, explicit signaling may be needed to inform the terminal device 110-1 about the updated measurement subset K1. For example, the input of the AI/ML model training can be updated based on the updated subset of resources. In other embodiments, the updated subset of resources can be transmitted in the first measurement configuration, which means that the configuration for collecting data for AI/ML model training can be updated. In this case, the RRC IE ‘RS-subset-to-measure-for-training’ and ‘RS-to-compare-for-training’ can be used for informing the updated subset of resources. Alternatively, the updated subset of resources can be transmitted in the second measurement configuration, which means that the configuration for collecting data for AI/ML model inference can be updated. In this case, a new signaling ‘RS-subset-measure-for-inference’ can be used for informing the updated subset of resources. As mentioned above, different AI/ML models can be used for different subset K1 selection. In other words, multiple AI/ML models (model i) can be learning how to generate K from different version of K1_i. In this case, instead of using K1′ as the output, the AI/ML model ID i can be used as output if one version of K1 selection corresponds one AI/ML model.

In some embodiments, the input from the terminal device 110-1 for the first AI/ML mode can comprise one or more of: number of Tx/Rx beam/panel, beamforming gain, beam width, location information, trajectory, velocity, orientation, moving direction, transmit power, measurement subset of Tx/Rx beams, transmission scheme, wide beam used in initial access. The input from the network device 120 for the AI/ML model can comprise one or more of: number of Tx/Rx beam/panel, beamforming gain, beam width, location information, transmit power, handover, measurement subset of Tx/Rx beams, scheduling information, beam switch decision, multi-user scheduling decision, traffic status, transmission scheme, wide beam used in initial access. The input from other terminal devices for the AI/ML model can comprise one or more of: number of Tx/Rx beam/panel, beamforming gain, beam width, location information, trajectory, velocity, orientation, moving direction, transmit power, measurement subset of Tx/Rx beams, transmission scheme, wide beam used in initial access. The input from other network devices for the AI/ML model may comprise one or more of: number of Tx/Rx beam/panel, beamforming gain, beam width, location information, transmit power, handover, measurement subset of Tx/Rx beams, scheduling information, beam switch decision, multi-user scheduling decision, traffic status, transmission scheme, wide beam used in initial access. The input from other AI/ML model for the AI/ML model can comprise one or more of: prediction of UE location, prediction of UE trajectory, prediction of handover, predication of initial access, prediction of channel state information (CSI).

In some embodiments, the output from the AI/ML model for the terminal device 110-1 can comprise one or more of: transmit power, beam switch decision, active subset of Tx/Rx beams, transmission scheme. The output from the AI/ML model for the network device 120 can comprise one or more of: transmit power, handover, active subset of Tx/Rx beams, scheduling, beam switch decision, multi-user scheduling decision, traffic status, transmission scheme. The output from the AI/ML model can be as input to other AI/ML model for prediction of UE location/trajectory, prediction of handover/load balancing/energy saving decision, prediction of CSI.

In some embodiments, an additional parameter related to number of reduced UE Rx beams can be used to determine the following when AI/ML model inference is applied: the number of RS resources configured in a RS resource set; measurement period requirement; measurement accuracy requirement. In some embodiments, this parameter can be indicated by the network device 120. Alternatively, this parameter can be reported by the terminal device 110-1. Alternatively, this parameter can be reported by the terminal device 110-1 in capability reporting. In other embodiments, this parameter can also be output of AI/ML model. In this way, it can guide configuration and to set performance requirement when AI/ML model inference is applied.

In some other embodiments, the number of occupied CSI processing units (CPUs) and CSI computation time may depend on the number of resources actually measured for beam quality in the first set of resources. For example, the number of occupied CPU can be NCPU (i.e., UE capability on maximum supported number of simultaneous CSI calculations) or K1+1 (i.e., the number of actually measured resources in the resource set, including the target resource). Alternatively, or in addition, the number of occupied CPU can be NCPU or K1 (i.e., the number of actually measured resources in the resource set) for the time span from CSI reference to the last symbol carrying RS in K1. The number of occupied CPU can be 1 for the time span from the first symbol carrying RS for k (i.e., the best resource) to the report. Alternatively, if there are two report configurations for collecting the discrimination information, the number of occupied CPU can be NCPU or K1 for the first report configuration and the number of occupied CPU can be K1+1 for the second report configuration, since the terminal device 110-1 needs to store the results of K1 to compare for the second report. In some embodiments, for the case of DCI triggered CSI report, Z and Z′ can stand for PDCCH to CSI report time and CSI-RS to CSI report time respectively. Dedicated Z and Z′ can be introduced for the report quantity set to a value of requiring input for AI/ML model training, and/or AI/ML model inference. In addition, the exact value can be based on capability reported by the terminal device 110-1.

In some embodiments, a terminal deice comprises circuitry configured to perform: receiving, at a terminal device and from a network device, a first configuration indicating at least one subset of resources from a first set of resources, wherein the at least one subset of resources is for constructing a first dataset for training a first artificial intelligent (AI)/machine learning (ML) model at the network device, and the first dataset comprises at least one of: a training dataset for model training, a validation dataset for model training, a test dataset for model training, or a dataset for model inference; and transmitting, to the network device, information on quality determination based on the at least one subset of resources, wherein the information is for constructing the first dataset.

In some embodiments, the first set of resources at least comprises resources for beam measurement and report. In some embodiments, the terminal deice comprises circuitry configured to perform: performing a reference signal (RS) quality measurement on the at least one subset of resources. In some embodiments, the terminal deice comprises circuitry configured to perform transmitting the information by: determining RS qualities on the at least one subset of resources based on the RS quality measurement; and transmitting, to the network device, the information about the RS qualities on the at least one subset of resources.

In some embodiments, the first configuration further comprises: a first candidate data sample for constructing the first dataset and a first report configuration. In some embodiments, the terminal deice comprises circuitry configured to perform transmitting the information by: transmitting, to the network device, a first report comprising the first report quantity which indicates whether the first candidate data sample is suitable for constructing the first dataset for the first AI/ML model.

In some embodiments, the first candidate data sample comprises a subset of resources as input of the first AI/ML model and a target resource as output of the first AI/ML model.

In some embodiments, the terminal deice comprises circuitry configured to perform determining qualities of the subset of resources based on a measurement on the subset of resources; determining a quality of the target resource based on a measurement on the target resource; and comparing the qualities of the subset of resources and the quality of the target resource. In some embodiments, the terminal deice comprises circuitry configured to perform transmitting the information by: transmitting, to the network device, a first report comprising a first report quantity which indicates a result of the comparison between the qualities of the subset of resources and the quality of the target resource.

In some embodiments, the first report quantity further comprises at least one of: a first index of the target resource with the quality of the target resource and indexes of the subset of resources with the qualities of the subset of resources, a second index of a best resource determined by the terminal device, indexes of a subset of measurement resources determined by the terminal device, a measured quality of the best resource, or measured qualities of the subset of measurement resources.

In some embodiments, the first configuration further comprises a first candidate data sample for constructing the first dataset and the first candidate data sample comprises a subset of resources as input of the first AI/ML model. In some embodiments, the terminal deice comprises circuitry configured to perform performing a measurement on the subset of resources; reporting, to the network device, qualities of the subset of resources based on the measurement on the subset of resources; receiving, from the network device, a second configuration indicates a target resource as output of the first AI/ML model; performing a measurement on the target resource; and determining a quality of the target resource based on the measurement on the target resource.

In some embodiments, the terminal deice comprises circuitry configured to transmit the information by: transmitting, to the network device, a first report comprising a quality of the target resource; or transmitting, to the network device, the first report comprising the first report quantity indicating a comparison result between the quality of the target resource and the qualities of the subset of resources.

In some embodiments, if at least one quality of the subset of resources is better than the quality of the target resource, the first report quantity indicates that the first candidate data sample is not suitable for constructing the first dataset for the first AI/ML model, and if the quality of the target resource is better than all qualities of the subset of resources, the first report quantity indicates that the first candidate data sample is suitable for constructing the first dataset for the first AI/ML model.

In some embodiments, the first set of resources comprises a set of reference signal resources, the at least one subset of resources comprises a subset of reference signal resources from the set of reference signal resources, the first configuration also indicates a target reference signal resource. In some embodiments, the terminal device comprises circuitry configured to perform transmitting the information by: transmitting a set of sounding reference signals on the set of reference signal resources to the network device; and transmitting a target sounding reference signal on the target reference signal resource to the network device.

In some embodiments, the terminal device is configured with a time offset between a last symbol carrying the set of sounding reference signals and a first symbol carrying the target sounding reference signal.

In some embodiments, the first set of resources comprises a set of reference signal resources, the at least one subset of resources comprises a subset of reference signal resources from the set of reference signal resources. In some embodiments, the terminal device comprises circuitry configured to perform transmitting the information by: transmitting a set of sounding reference signals on the set of reference signal resources to the network device. In some embodiments, the terminal device comprises circuitry configured to perform receiving, from the network device, a second configuration indicates a target reference signal resource; transmitting a target sounding reference signal on the target reference signal resource to the network device.

In some embodiments, the first configuration indicates the terminal device to perform a measurement on the first set of resources. In some embodiments, the terminal device comprises circuitry configured to perform performing a measurement on the first set of resources; determining qualities of the first set of resources based on the measurement on the first set of resources. In some embodiments, the terminal device comprises circuitry configured to perform transmitting the information by: transmitting, to the network device, a second report indicating the qualities of the first set of resources.

In some embodiments, the second report comprises at least one of: indexes of the first set of resources and the qualities of the first set of resources, indexes of a subset of resources from the first set of resources and qualities of the subset of resources which exceed a predetermined threshold, or difference qualities of the first set of resources with respect to reference qualities of the first set of resources.

In some embodiments, the first set of resources comprises a set of reference signal resources and the first configuration indicates the terminal device to transmit sounding reference signals on the set of reference signal resources. In some embodiments, the terminal device comprises circuitry configured to perform transmitting the information by: transmitting the sounding reference signals on the set of reference signal resources to the network device.

In some embodiments, the terminal device comprise circuitry configured to perform receiving, from the network device, an indication of an updated subset of resources from the first set of resources, wherein the updated subset of resources is output from the first AI/ML model. In some embodiments, the terminal device comprise circuitry configured to perform receiving the indication by: receiving, from the network device, the first configuration comprising the indication of the updated subset of resources, or receiving, from the network device, a second configuration for inference of the data processing model comprising the indication of the updated subset of resources.

In some embodiments, at least one of the followings is determined based on a number of receiving beams applied during inference of the AI/ML model: the number of reference signal resources configured in a reference signal resource set, a measurement period requirement, or a measurement accuracy requirement, and wherein the number of receiving beams applied during inference of the first AI/ML model is indicated by the network device or determined by the terminal device, or wherein the number of receiving beams applied during inference of the first AI/ML model is output by the AI/ML model.

In some embodiments, the number of channel state information (CSI) processing units and CSI computation time depend on the number of resources measured for beam quality in the first set of resources.

In some embodiments, a network device comprises circuitry configured to perform transmitting, at a network device and to a terminal device, a first configuration indicating at least one subset of resources from a first set of resources, wherein the at least one subset of resources is for constructing a first dataset for training a first artificial intelligent (AI)/machine learning (ML) model at the network device, and the first dataset comprises at least one of: a training dataset for model training, a validation dataset for model training, a test dataset for model training, or a dataset for model inference; and receiving, from the terminal device, information on quality determination based on the at least one subset of resources, wherein the information is for constructing the first dataset.

In some embodiments, the first set of resources at least comprises resources for beam measurement and report. In some embodiments, the network device comprises circuitry configured to perform receiving the information by: receiving, from the terminal device, the information about reference signal (RS) qualities on the at least one subset of resources. In some embodiments, the network device comprises circuitry configured to perform training the AI/ML model based on the RS qualities of the set of beam pairs.

In some embodiments, the first configuration further comprises: a first candidate data sample for constructing the first dataset. In some embodiments, the network device comprises circuitry configured to perform receiving the information by: receiving, from the terminal device, a first report comprising a first report quantity which indicates whether the first candidate data sample is suitable for constructing the first dataset for the first AI/ML model.

In some embodiments, the first candidate data sample comprises a subset of resources as input of the first AI/ML model and a target resource as output of the first AI/ML model.

In some embodiments, the network device comprises circuitry configured to perform receiving the information by: receiving, from the terminal device, a first report comprising a first report quantity which indicates a result of the comparison between qualities of the subset of resources and a quality of the target resource.

In some embodiments, first report quantity further comprises at least one of: a first index of the target resource with the quality of the target resource and indexes of the subset of resources with the qualities of the subset of resources, a second index of a best resource determined by the terminal device, indexes of a subset of measurement resources determined by the terminal device, a measured quality of the best resource, or measured qualities of the subset of measurement resources.

In some embodiments, the first configuration further comprises a first candidate data sample for constructing the first dataset and the first candidate data sample comprises a subset of resources as input of the first AI/ML model. In some embodiments, the network device comprises circuitry configured to perform transmitting, to the terminal device, a second configuration indicates a target resource as output of the first AI/ML model.

In some embodiments, the network device comprises circuitry configured to perform receiving the information by: receiving, from the terminal device, a first report comprising a quality of the target resource; or receiving, from the terminal device, the first report comprising a first report quantity which indicates a comparison result between the quality of the target resource and the qualities of the subset of resources.

In some embodiments, if at least one quality of the subset of resources is better than the quality of the target resource, the first report quantity indicates that the first candidate data sample is not suitable for constructing the first dataset for the first AI/ML model, and if the quality of the target resource is better than all qualities of the subset of resources, the first report quantity indicates that the first candidate data sample is suitable for constructing the first dataset for the first AI/ML model.

In some embodiments, the first set of resources comprises a set of reference signal resources, the at least one subset of resources comprises a subset of reference signal resources from the set of reference signal resources, the first configuration also indicates a target reference signal resource. In some embodiments, the network device comprises circuitry configured to perform receiving the information by: receiving a set of sounding reference signals on the set of reference signal resources from the terminal device; and receiving a target sounding reference signal on the target reference signal resource from the terminal device.

In some embodiments, the first set of resources comprises a set of reference signal resources, the at least one subset of resources comprises a subset of reference signal resources from the set of reference signal resources. In some embodiments, the network device comprises circuitry configured to perform receiving the information by: receiving a set of sounding reference signals on the set of reference signal resources from the terminal device. In some embodiments, the network device comprises circuitry configured to perform transmitting, to the terminal device, a second configuration indicates a target reference signal resource; receiving a target sounding reference signal on the target reference signal resource from the terminal device.

In some embodiments, the first configuration indicates the terminal device to perform a measurement on the first set of resources. In some embodiments, the network device comprises circuitry configured to perform receiving the information by: receiving, from the terminal device, a second report indicating qualities of the first set of resources.

In some embodiments, the second report comprises at least one of: indexes of the first set of resources and the qualities of the first set of resources, indexes of a subset of resources from the first set of resources and qualities of the subset of resources which exceed a predetermined threshold, or difference qualities of the first set of resources with respect to reference qualities of the first set of resources.

In some embodiments, the first set of resources comprises a set of reference signal resources and the first configuration indicates the terminal device to transmit sounding reference signals on the set of reference signal resources. In some embodiments, the network device comprises circuitry configured to perform receiving the information by: receiving the sounding reference signals on the set of reference signal resources from the terminal device.

In some embodiments, the network device comprises circuitry configured to perform obtaining an updated subset of resources from output of the first AI/ML model; transmitting, to the terminal device, an indication of the updated subset of resources. In some embodiments, the network device comprises circuitry configured to perform transmitting the indication by: transmitting, to the terminal device, the first configuration comprising the indication of the updated subset of resources, or transmitting, to the terminal device, a second configuration for inference of the data processing model comprising the indication of the updated subset of resources.

In some embodiments, at least one of the followings is determined based on a number of receiving beams applied during inference of the AI/ML model: the number of reference signal resources configured in a reference signal resource set, a measurement period requirement, or a measurement accuracy requirement, and wherein the number of receiving beams applied during inference of the first AI/ML model is indicated by the network device or determined by the terminal device, or wherein the number of receiving beams applied during inference of the first AI/ML model is output by the AI/ML model.

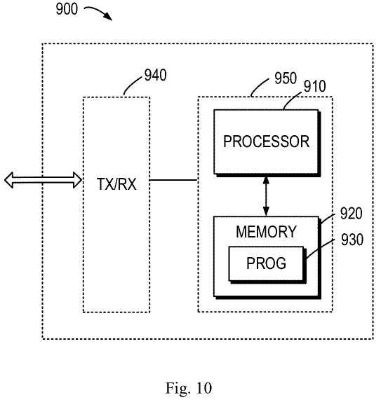

FIG. 10 is a simplified block diagram of a device 900 that is suitable for implementing embodiments of the present disclosure. The device 900 can be considered as a further example implementation of the terminal device 110 as shown in FIG. 1. Accordingly, the device 900 can be implemented at or as at least a part of the terminal device 110. Alternatively, the device 900 can be considered as a further example implementation of the network device 120 as shown in FIG. 1. Accordingly, the device 900 can be implemented at or as at least a part of the network device 120.

As shown, the device 900 includes a processor 910, a memory 920 coupled to the processor 910, a suitable transmitter (TX) and receiver (RX) 940 coupled to the processor 910, and a communication interface coupled to the TX/RX 940. The memory 920 stores at least a part of a program 930. The TX/RX 940 is for bidirectional communications. The TX/RX 940 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 930 is assumed to include program instructions that, when executed by the associated processor 910, enable the device 900 to operate in accordance with the embodiments of the present disclosure, as discussed herein with reference to FIGS. 3 to 8. The embodiments herein may be implemented by computer software executable by the processor 910 of the device 900, or by hardware, or by a combination of software and hardware. The processor 910 may be configured to implement various embodiments of the present disclosure. Furthermore, a combination of the processor 910 and memory 920 may form processing means 950 adapted to implement various embodiments of the present disclosure.

The memory 920 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 920 is shown in the device 900, there may be several physically distinct memory modules in the device 900. The processor 910 may be of any type suitable to the local technical network, and may include one or more of general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2 to 9. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (Iota) devices, Ultra-reliable and Low Latency Communications (URLLC) devices, Internet of Everything (Iowa) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and Iota applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (Node or NB), an evolved Node (anode or eNB), a next generation Node (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz-7125 MHz), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

What is claimed is:

1. A communication method, comprising:
receiving, at a terminal device and from a network device, a first configuration indicating at least one subset of resources from a first set of resources, wherein the at least one subset of resources is for constructing a first dataset for training a first artificial intelligent (AI) or machine learning (ML) model at the network device, and the first dataset comprises at least one of: a training dataset for model training, a validation dataset for model training, a test dataset for model training, or a dataset for model inference; and
transmitting, to the network device, information on quality determination based on the at least one subset of resources, wherein the information is for constructing the first dataset.

2. The method of claim 1, wherein the first set of resources at least comprises resources for beam measurement and report, and
wherein the method further comprises:
performing a reference signal (RS) quality measurement on the at least one subset of resources; and
wherein transmitting the information comprises:
determining RS qualities on the at least one subset of resources based on the RS quality measurement; and
transmitting, to the network device, the information about the RS qualities on the at least one subset of resources.

3. The method of claim 1, wherein the first configuration further comprises: a first candidate data sample for constructing the first dataset and a first report configuration, and
wherein transmitting the information comprises:
transmitting, to the network device, a first report comprising the first report quantity which indicates whether the first candidate data sample is suitable for constructing the first dataset for the first AI or ML model.

4. The method of claim 3, wherein the first candidate data sample comprises a subset of resources as input of the first AI or ML model and a target resource as output of the first AI or ML model.

5. The method of claim 4, further comprising:
determining qualities of the subset of resources based on a measurement on the subset of resources;
determining a quality of the target resource based on a measurement on the target resource; and
comparing the qualities of the subset of resources and the quality of the target resource; and
wherein transmitting the information comprises:
transmitting, to the network device, a first report comprising a first report quantity which indicates a result of the comparison between the qualities of the subset of resources and the quality of the target resource.

6. The method of claim 5, wherein the first report quantity further comprises at least one of:
a first index of the target resource with the quality of the target resource and indexes of the subset of resources with the qualities of the subset of resources,
a second index of a best resource determined by the terminal device,
indexes of a subset of measurement resources determined by the terminal device,
a measured quality of the best resource, or
measured qualities of the subset of measurement resources.

7. The method of claim 1, wherein the first configuration further comprises a first candidate data sample for constructing the first dataset and the first candidate data sample comprises a subset of resources as input of the first AI or ML model, and
wherein the method further comprises:
performing a measurement on the subset of resources;
reporting, to the network device, qualities of the subset of resources based on the measurement on the subset of resources;
receiving, from the network device, a second configuration indicates a target resource as output of the first AI or ML model;
performing a measurement on the target resource; and
determining a quality of the target resource based on the measurement on the target resource.

8. The method of claim 7, wherein transmitting the information comprises:
transmitting, to the network device, a first report comprising a quality of the target resource; or
transmitting, to the network device, the first report comprising the first report quantity indicating a comparison result between the quality of the target resource and the qualities of the subset of resources.

9. The method of claim 6 or 8, wherein if at least one quality of the subset of resources is better than the quality of the target resource, the first report quantity indicates that the first candidate data sample is not suitable for constructing the first dataset for the first AI or ML model, and
if the quality of the target resource is better than all qualities of the subset of resources, the first report quantity indicates that the first candidate data sample is suitable for constructing the first dataset for the first AI or ML model.

10. The method of claim 1, wherein the first set of resources comprises a set of reference signal resources, the at least one subset of resources comprises a subset of reference signal resources from the set of reference signal resources, the first configuration also indicates a target reference signal resource, and
wherein transmitting the information comprises:
transmitting a set of sounding reference signals on the set of reference signal resources to the network device; and
transmitting a target sounding reference signal on the target reference signal resource to the network device.

11. The method of claim 10, wherein the terminal device is configured with a time offset between a last symbol carrying the set of sounding reference signals and a first symbol carrying the target sounding reference signal.

12. The method of claim 1, wherein the first set of resources comprises a set of reference signal resources, the at least one subset of resources comprises a subset of reference signal resources from the set of reference signal resources, and
wherein transmitting the information comprises:
transmitting a set of sounding reference signals on the set of reference signal resources to the network device; and
wherein the method further comprises:
receiving, from the network device, a second configuration indicates a target reference signal resource;
transmitting a target sounding reference signal on the target reference signal resource to the network device.

13. The method of claim 1, wherein the first configuration indicates the terminal device to perform a measurement on the first set of resources, and
wherein the method further comprises:
performing a measurement on the first set of resources;
determining qualities of the first set of resources based on the measurement on the first set of resources; and
wherein transmitting the information comprises:
transmitting, to the network device, a second report indicating the qualities of the first set of resources.

14. The method of claim 13, wherein the second report comprises at least one of:
indexes of the first set of resources and the qualities of the first set of resources,
indexes of a subset of resources from the first set of resources and qualities of the subset of resources which exceed a predetermined threshold, or
difference qualities of the first set of resources with respect to reference qualities of the first set of resources.

15. The method of claim 1, wherein the first set of resources comprises a set of reference signal resources and the first configuration indicates the terminal device to transmit sounding reference signals on the set of reference signal resources; and
wherein transmitting the information comprises:
transmitting the sounding reference signals on the set of reference signal resources to the network device.

16. The method of claim 1, further comprising:
receiving, from the network device, an indication of an updated subset of resources from the first set of resources, wherein the updated subset of resources is output from the first AI or ML model; and
wherein receiving the indication comprises:
receiving, from the network device, the first configuration comprising the indication of the updated subset of resources, or
receiving, from the network device, a second configuration for inference of the AI or ML model comprising the indication of the updated subset of resources.

17. The method of any one of claim 1-16, wherein at least one of the followings is determined based on a number of receiving beams applied during inference of the first AI or ML model:
the number of reference signal resources configured in a reference signal resource set,
a measurement period requirement, or
a measurement accuracy requirement, and
wherein the number of receiving beams applied during inference of the first AI or ML model is indicated by the network device or determined by the terminal device, or wherein the number of receiving beams applied during inference of the first AI or ML model is output by the first AI or ML model.

18. The method of claim 1, wherein the number of channel state information (CSI) processing units and CSI computation time depend on the number of resources actually measured for beam quality in the first set of resources.

19. A communication method, comprising:
transmitting, at a network device and to a terminal device, a first configuration indicating at least one subset of resources from a first set of resources, wherein the at least one subset of resources is for constructing a first dataset for training a first artificial intelligent (AI) or machine learning (ML) model at the network device, and the first dataset comprises at least one of: a training dataset for model training, a validation dataset for model training, a test dataset for model training, or a dataset for model inference; and
receiving, from the terminal device, information on quality determination based on the at least one subset of resources, wherein the information is for constructing the first dataset.

20. The method of claim 19, wherein the first set of resources at least comprises resources for beam measurement and report, and
wherein receiving the information comprises:
receiving, from the terminal device, the information about reference signal (RS) qualities on the at least one subset of resources; and
wherein the method further comprises:
training the first AI or ML model based on the RS qualities of the set of beam pairs.

21. The method of claim 19, wherein the first configuration further comprises: a first candidate data sample for constructing the first dataset, and
wherein receiving the information comprises:
receiving, from the terminal device, a first report comprising a first report quantity which indicates whether the first candidate data sample is suitable for constructing the first dataset for the first AI or ML model.

22. The method of claim 21, wherein the first candidate data sample comprises a subset of resources as input of the first AI or ML model and a target resource as output of the first AI or ML model.

23. The method of claim 22, wherein receiving the information comprises:
receiving, from the terminal device, a first report comprising a first report quantity which indicates a result of the comparison between qualities of the subset of resources and a quality of the target resource.

24. The method of claim 23, wherein the first report quantity further comprises at least one of:
a first index of the target resource with the quality of the target resource and indexes of the subset of resources with the qualities of the subset of resources,
a second index of a best resource determined by the terminal device,
indexes of a subset of measurement resources determined by the terminal device,
a measured quality of the best resource, or
measured qualities of the subset of measurement resources.

25. The method of claim 19, wherein the first configuration further comprises a first candidate data sample for constructing the first dataset and the first candidate data sample comprises a subset of resources as input of the first AI or ML model, and
wherein the method further comprises:
transmitting, to the terminal device, a second configuration indicates a target resource as output of the first AI or ML model.

26. The method of claim 25, wherein receiving the information comprises:
receiving, from the terminal device, a first report comprising a quality of the target resource; or
receiving, from the terminal device, the first report comprising a first report quantity which indicates a comparison result between the quality of the target resource and the qualities of the subset of resources.

27. The method of claim 24 or 26, wherein if at least one quality of the subset of resources is better than the quality of the target resource, the first report quantity indicates that the first candidate data sample is not suitable for constructing the first dataset for the first AI or ML model, and
if the quality of the target resource is better than all qualities of the subset of resources, the first report quantity indicates that the first candidate data sample is suitable for constructing the first dataset for the first AI or ML model.

28. The method of claim 19, wherein the first set of resources comprises a set of reference signal resources, the at least one subset of resources comprises a subset of reference signal resources from the set of reference signal resources, the first configuration also indicates a target reference signal resource, and
wherein receiving the information comprises:
receiving a set of sounding reference signals on the set of reference signal resources from the terminal device; and
receiving a target sounding reference signal on the target reference signal resource from the terminal device.

29. The method of claim 19, wherein the first set of resources comprises a set of reference signal resources, the at least one subset of resources comprises a subset of reference signal resources from the set of reference signal resources, and
wherein receiving the information comprises:
receiving a set of sounding reference signals on the set of reference signal resources from the terminal device; and
wherein the method further comprises:
transmitting, to the terminal device, a second configuration indicates a target reference signal resource;
receiving a target sounding reference signal on the target reference signal resource from the terminal device.

30. The method of claim 19, wherein the first configuration indicates the terminal device to perform a measurement on the first set of resources, and
wherein receiving the information comprises:
receiving, from the terminal device, a second report indicating qualities of the first set of resources.

31. The method of claim 30, wherein the second report comprises at least one of:
indexes of the first set of resources and the qualities of the first set of resources,
indexes of a subset of resources from the first set of resources and qualities of the subset of resources which exceed a predetermined threshold, or
difference qualities of the first set of resources with respect to reference qualities of the first set of resources.

32. The method of claim 19, wherein the first set of resources comprises a set of reference signal resources and the first configuration indicates the terminal device to transmit sounding reference signals on the set of reference signal resources; and
wherein receiving the information comprises:
receiving the sounding reference signals on the set of reference signal resources from the terminal device.

33. The method of claim 19, further comprising:
obtaining an updated subset of resources from output of the first AI or ML model;
transmitting, to the terminal device, an indication of the updated subset of resources; and
wherein transmitting the indication comprises:
transmitting, to the terminal device, the first configuration comprising the indication of the updated subset of resources, or
transmitting, to the terminal device, a second configuration for inference of the first AI or ML model comprising the indication of the updated subset of resources.

34. The method of any one of claim 1-33, wherein at least one of the followings is determined based on a number of receiving beams applied during inference of the first AI or ML model:
the number of reference signal resources configured in a reference signal resource set,
a measurement period requirement, or
a measurement accuracy requirement, and
wherein the number of receiving beams applied during inference of the first AI or ML model is indicated by the network device or determined by the terminal device, or wherein the number of receiving beams applied during inference of the first AI or ML model is output by the first AI or ML model.

35. A terminal device comprising:
a processor; and
a memory coupled to the processor and storing instructions thereon, the instructions, when executed by the processor, causing the terminal device to perform acts comprising the method according to any of claims 1-18.

36. A network device comprising:
a processor; and
a memory coupled to the processor and storing instructions thereon, the instructions, when executed by the processor, causing the network device to perform acts comprising the method according to any of claims 19-34.

37. A computer readable medium having instructions stored thereon, the instructions, when executed on at least one processor, causing the at least one processor to perform the method according to any of claims 1-18 or any of claims 19-34.
